(19) United States
(12) Patent Application Publication
(10) Pub. No.: US 2012/0212975 A1
(43) Pub. Date: Aug. 23, 2012

(54) LIGHT GUIDE UNIT, ILLUMINATION DEVICE AND DISPLAY DEVICE

(75) Inventor: Takeshi Masuda, Osaka-shi (JP)

(73) Assignee: SHARP KABUSHIKI KAISHA, Osaka-shi, Osaka (JP)

(21) Appl. No.: 13/504,965

(22) PCT Filed: Nov. 11, 2010
(86) PCT No.: PCT/JP2010/070089

§ 371 Date: Apr. 30, 2012

(30) Foreign Application Priority Data
Dec. 22, 2009 (JP) 2009-290037
Mar. 8, 2010 (JP) 2010-050636
May 17, 2010 (JP) 2010-113449

(51) Int. Cl. F21V 7/00; F21V 11/00

(52) U.S. Cl. 362/606; 362/609

(57) ABSTRACT

Provided are an illumination device that does not use a portion for shielding a light source, a light guide unit necessary for the illumination device and a display device incorporating the illumination device. In a light guide bar group (GR), a light emission portion arrangement line (S) formed by connecting the positions of processing portions (13) included in light guide bars (11) intersects a light receiving end arrangement line (T) formed by connecting positions of light receiving ends (12R) included in the light guide bars (11).

### TECHNICAL FIELD

The present invention relates to a light guide unit that is formed with light guide members for guiding light, an illumination device incorporating the light guide unit and a display device incorporating the illumination device.

### BACKGROUND ART

In a liquid crystal display device (display device) incorporating a liquid crystal display panel (display panel) that does not emit light, in general, a backlight unit (illumination device) that supplies light to the liquid crystal display panel is also incorporated. The backlight unit preferably generates planar light that is spread over the entire liquid crystal display panel of a planar shape. Hence, the backlight unit may include a light guide member for mixing the light of an internal light source (for example, a light emitting element such as an LED) to a high degree.

For example, as shown in the cross-sectional view of FIG. 40A and the perspective view of FIG. 40B, a backlight unit disclosed in patent document 1 includes a light source 132, a light bar 111 that is a light guide member and a reflective box 171. Specifically, the light source 132 supplies light to the light receiving end 112R of the light bar 111, and the light bar 111 guides the received light and emits the light to the outside at a light direction conversion feature portion 113 and a reflective member 114 incorporated therein. The reflective box 171 receives, through an opening 171p, the light from the light bar 111, reflects it therewithin and then outputs it to the outside.

When the reflective box 171 described above is present, the light from the light bars 111 are reflected and thereby mixed to a high degree, with the result that the light is more likely to become high-quality planar light.

### RELATED ART DOCUMENT

### Patent Document

Patent document 1: JP-A-2009-26743

### DISCLOSURE OF THE INVENTION

### Problems to be Solved by the Invention

Incidentally, in the backlight unit 149 described above, the light sources 132 and the light bars 111 that receive the light from the light sources 132 are arranged not only around the ends of the bottom surface of the backlight unit 149 but also around the center. Hence, the reflective box 171 is hidden so that a user does not recognize the light sources 132.

Specifically, in the reflective box 171, the opening 171p is made to coincide with the position of the light emission portion of the light bar 111, and the portions other than the openings 171p are made to coincide with the positions of the light sources 132 (in short, in addition to the burdensomeness of the manufacturing of the backlight unit 149, the increase in the number of components causes the cost of the backlight unit 149 to be increased).

Moreover, in the reflective box 171 arranged as described above, while the light is taken in through the openings 171p and is reflected therewith, part of the light is returned to the openings 171p, and cannot be emitted to the outside. In other words, the part of the light does not reach the liquid crystal display panel, and is lost.

The present invention is made in view of the foregoing conditions. An object of the present invention is to provide an illumination device that does not use a component, such as a reflective box, which interrupts a light source, a light guide unit that is needed in such an illumination device and a display device that incorporates the illumination device.

### Means for Solving the Problem

A light guide unit includes one or a plurality of light guide member groups (the light guide member group is a component where a plurality of light guide members which include a light receiving end for receiving light and which guide the received light are aligned). This light guide unit includes: a light propagation portion that propagates the received light by reflecting the received light multiple times within the light propagation portion; and a light emission portion that emits the propagated light to an outside. In the light guide member group, a light receiving end arrangement line formed by connecting positions of the light receiving ends intersects a light emission portion arrangement line formed by connecting positions of the light emission portions.

In this configuration, even when a light source or the like is arranged to face the light receiving end of the light guide member, light from the light source is emitted from the light emission portion of the light guide member. Hence, even when the light receiving end of the light guide unit is arranged, for example, in the vicinity of an end that is a non-display portion of a display panel of a display device, the light emission portion that emits light is arranged within the panel that is a display portion of the display panel (for example, is arranged close to the vicinity of the center of the display panel).

Thus, when the light guide unit is incorporated in an illumination device, and hence the display device, for example, a member for hiding the light source is not needed, and the lack of such a member allows the light from the light emission portion to travel in a desired direction without being disturbed, and prevents the light from being lost. Therefore, when the light guide unit is incorporated in the illumination device, it is possible to enhance the efficiency of utilization of the light and reduce the cost of the illumination device and the like.

Moreover, the light guide member groups each of which is an aggregation of the relatively small light guide members are arranged close to each other and thus become the large light guide unit, with the result that the light guide unit can acquire the amount of light suitable for a large illumination device. Since, in the light guide unit, light is not exchanged between the light guide members, it is possible to control the emission of the light for each of the light guide members (in short, the emission of the light is controlled according to the light guide members of the light guide unit). Hence, when the light guide unit is incorporated in the illumination device, it can be said to be a member suitable for local dimming control.

In the light guide unit described above, the number of small light guide members or the number of light guide member groups is changed, and thus the maximum amount of light is freely changed, and furthermore, the positions of the light emission portions that emit light are not arranged close to each other. Hence, when the light guide unit is incorporated in the display device, it is easily made to correspond to the display area of the display device, and furthermore, the planar light is guided in a wide range.

For example, although, when one light guide plate is used, it is necessary to change a manufacturing mold according to the display area of the display device, in the light guide unit, the number of light guide members or light guide member groups can be changed without any change of the manufacturing mold, and thus it is possible to correspond to the display area of the display device. Hence, the cost of the light guide unit can be said to be low.

Preferably, the light emission portion includes an optical path change processing portion that is either a portion in which a fine shape for converting internal light into an optical path suitable for external emission is processed or a portion which is subjected to dot-type printing processing. Specifically, the optical path change processing portion is a member that changes the refraction angle of the light propagated in a light propagation portion and thereby emits the light from the light emission portion to the outside. The portion where the fine shape is processed is preferably a portion that has been subjected to prism processing, a portion that has been subjected to grain processing or the like; it may be a portion other than those portions.

The shape of the light guide member varies greatly, and accordingly, the shape of the light guide member and hence the shape of the light guide unit vary greatly. For example, the light guide member is bar-shaped, the light emission portion is arranged in the side of a bar-shaped top end opposite to the side of the light receiving end of the light and, in the light guide member group, the light guide members may have a plurality of different lengths.

In this configuration, for example, the light receiving ends of the light guide members are only arranged in a row, and thus the positions (hence, the positions of the light emission portions) that emit light from the light guide member to the outside are not along the direction in which the light receiving ends are aligned. Hence, the light guide unit can guide the light in a direction perpendicular to the direction in which the light receiving ends are aligned (for example, when the light guide unit is incorporated in the display device, it can guide the light toward the vicinity of the center of a display screen).

The light emission portion of the light guide member is preferably tapered. In this configuration, the possibility that the light reaches the optical path change processing portion and is emitted from the light emission portion to the outside is increased. Hence, since the light that reaches the top end of the light guide member and exits from the top end is reduced, a bright spot is unlikely to occur. (Specifically, if the light guide bar is not tapered, the amount of light that reaches the top end of the light guide bar is relatively increased, and thus the bright spot is easily produced by the light emitted from the top end).

The optical path change processing portion is planar, and a planar direction thereof may be parallel to an arrangement plane direction in which a plurality of light guide members are aligned; the planar direction thereof may intersect an arrangement plane direction in which a plurality of light guide members are aligned.

When the planar direction of the optical path change processing portion intersects the arrangement plane direction in which a plurality of light guide members are aligned, if the light enters, for example, a planar member (for example, the diffusion member) arranged parallel to the arrangement plane direction from the light emission portion through the optical path change processing portion, most of the light travels to intersect the arrangement plane direction. Hence, the optical path from the optical path change processing portion to the planar member is extended, and the application area of the planar member to which light is applied is increased. Therefore, in the planar member, a large number of application parts are overlapped, and thus variations in the amount of light are unlikely to be produced (in short, parts of the planar member to which light is not applied is reduced).

When the light guide member is bar-shaped, the optical path change processing portion is preferably formed in at least one of side surfaces of the bar.

In this configuration, the direction of emission of the light is easily changed according to the position of the side surface formed in the optical path change processing portion. The bar is only inclined, and thus the direction of emission of the light from the light guide member is easily changed.

In one surface of the light guide member opposite the optical path change processing portion, a lens for diffusing light from the optical path change processing portion is preferably formed.

In this configuration, in the light emission portion, the light travelling from the optical path change processing portion is emitted to the outside while being diffused by passing through the lens. Hence, for example, when the light enters the planar member (for example, the diffusion member) arranged to cover the lens, the width of the light beam of the light is increased. Then, the application area of the planar member to which light is applied is increased, and a large number of application parts are overlapped, with the result that variations in the amount of light are unlikely to be produced.

The light emission portion arrangement line in the light guide unit is preferably straight.

For example, when light from the light guide unit is supplied to the rectangular display panel of the display device, if the light is along the longitudinal direction or the width direction of the display panel, a user can easily see it in terms of visual characteristics. Hence, when the light emission portion arrangement line where the light emission portions emitting light are continuous is straight, the light guide unit thereof can be said to be suitable for the display device.

Preferably, the light receiving end arrangement line intersects a direction in which the light guide members are aligned, and is perpendicular to the light emission portion arrangement line.

For example, when, in the light guide member group, the light receiving end arrangement line is parallel to the direction in which the light guide members are aligned, if the light emission portion is arranged in the top end of the light guide member, the light emission portion arrangement line is straight but intersects the light receiving end arrangement line at an acute angle. Then, for example, when the light receiving end arrangement line is overlapped with the longitudinal side of the rectangular display panel, the light emission portion arrangement line is inclined with respect to the width side of the display panel; when the user see the display panel, the line of the light inclined with respect to the width side of the display panel is likely to become noticeable.

However, when, in the light guide member group, the light receiving end arrangement line intersects the direction in which the light guide members are aligned, and the light receiving end arrangement line is perpendicular to the light emission portion arrangement line, if, for example, the light receiving end arrangement line is arranged in the longitudinal side of the display panel, the light emission portion arrangement line is parallel to the width side of the display panel. Hence, when the user see the display panel, the line of the light is seen to be parallel to the width side of the display panel, and thus the line is not noticeable.

Incidentally, when the light receiving end arrangement line intersects the direction in which the light guide members are aligned, while light entering the light guide member from the light receiving end is travelling toward the light propagation portion, the light is likely to leak to the outside (in short, the light is likely to be incident on the side surface of the light guide member at an angle less than the critical angle of the material of the light guide member). Then, depending on the critical angle, the limit value of the inclination of the light guide member is determined, and furthermore, the arrangement distance between the light guide members is also determined to achieve such inclination. An example of the relational formula for the arrangement distance between the light guide members described above is as follows.

P≦(L/m)×tan(90°−2×θc) Relational formula (1)

where P: an arrangement distance between the light guide members in the light guide member group, L: a length from the light receiving end of the light guide member having a shortest length to a top end in an opposite side of the light receiving end of the light guide member having a longest length, m: the number of the light guide members included in the light guide member group and θc: a critical angle of a material of the light guide member.

Preferably, the light guide member is bent and bar-shaped, and, in a portion extending from a bent place of the bar to the side of the top end of the bar in the opposite side to the side of the light receiving end of the light, the light emission portion is arranged, and a direction in which the light emission portion extends is perpendicular to the light receiving end arrangement line.

In this configuration, for example, the light receiving ends of the light guide members are only arranged in a row, and thus the positions of the light emission portions that emit light from the light guide member to the outside are not along the direction in which the light receiving ends are aligned. Hence, the light guide unit can guide the light in a direction perpendicular to the direction in which the light receiving ends are aligned (for example, when the light guide unit is incorporated in the display device, it can guide the light toward the vicinity of the center of a display screen).

Preferably, in the light guide member group, when the light guide member is bar-shaped, as the length of the light guide member is greater, the area of the optical path change processing portion is smaller (in other words, preferably, in the light guide member group, as the length of the light guide member is shorter, the area of the optical path change processing portion is larger).

When, in the light guide member group, the amount of light received by the light guide member is equal, the brightness of the light emitted from the light guide member varies inversely with the area of the optical path change processing portion. In general, in terms of the visual characteristics of people, the perimeter of the display panel does not become noticeable as compared with the center thereof even when it is dark. Then, the long light guide member in which the area of the optical path change processing portion is relatively reduced can emit light of high brightness, and moreover, the position from which light is emitted is the top end of the light guide member. Hence, in the light guide unit described above, the top end of the light guide member can be made to reach the center of the display panel.

In the light guide member group, the light guide members are preferably connected using a coupling member.

In this configuration, the light guide member groups can be individually carried, and thus it is possible to easily manufacture the light guide unit.

Preferably, a plurality of light guide member groups are symmetrically arranged about a symmetrical axis extending in the same direction as the light receiving end arrangement line. Furthermore, the plurality of light guide member groups may be symmetrically arranged about a symmetrical axis extending in a direction perpendicular to the light receiving end arrangement line.

An illumination device including: the light guide unit described above; a diffusion member that receives light emitted from the light emission portion; and a reflective member that sandwiches the light guide unit together with the diffusion member can also be said to be one aspect of the present invention.

Preferably, the optical path change processing portion is planar, and a light receiving side in the surface thereof faces the diffusion member or the reflective member.

In this configuration, when the light receiving side of the optical path change processing portion faces the diffusion member, the distance from the optical path change processing portion to the diffusion member is made longer. When the light receiving side of the optical path change processing portion faces the reflective member, the light from the light guide unit is reflected off the diffusion member, then is reflected off the reflective member reaching the diffusion member and then reaches the diffusion member. Hence, in any case, the optical path of the light is relatively made longer, and the application area of the diffusion member to which light is applied is increased. Therefore, in the diffusion member, a large number of application parts are overlapped, and thus variations in the amount of light are unlikely to be produced.

Preferably, in terms of the extension of the optical path, when the light receiving side of the optical path change processing portion faces the diffusion member, one surface of the light guide member formed in the optical path change processing portion is farthest away from the diffusion member as compared with the other surfaces whereas, when the light receiving side of the optical path change processing portion faces the reflective member, one surface of the light guide member formed in the optical path change processing portion is farthest away from the reflective member as compared with the other surfaces.

Preferably, when the light receiving side of the optical path change processing portion faces the diffusion member, a distance from the diffusion member to the optical path change processing portion is longer than a distance from the reflective member to the optical path change processing portion. Preferably, when the light receiving side of the optical path change processing portion faces the reflective member, a distance from the reflective member to the optical path change processing portion is longer than a distance from the diffusion member to the optical path change processing portion. This is because the optical path is made longer as much as possible.

Furthermore, more preferably, the optical path change processing portion is provided in a surface of the light guide member perpendicular to the reflective member, and is also provided in a surface of the light guide member opposite the reflective member. In this configuration, the light from the light guide members can be overlapped in a wide range, and the optical path change processing portion provided in the surface opposite the reflective member of the light guide member can effectively reduce the occurrence of a dark spot. In this way, it is possible to effectively reduce the occurrence of variations in the amount of light. Moreover, since, even when the distance between the diffusion member and the reflective member is reduced, the occurrence of the dark spot can be reduced, it is possible to more reduce the thickness of the illumination device.

A display device including: the illumination device described above; and a display panel that receives light from the illumination device can also be said to be one aspect of the present invention.

Preferably, in the display device described above, the light emission portion arrangement line is straight, and is along the longitudinal direction or the width direction of the display panel.

In this configuration, when the user see the display panel, the line of the light that is also the light emission portion arrangement line is seen to be parallel to the width side of the display panel, and thus the line is not noticeable in terms of visual characteristics.

### ADVANTAGES OF THE INVENTION

In the light guide unit according to the present invention, the light receiving end arrangement line of the light guide members intersects the light emission portion arrangement line that guides light to the outside, and thus the position where light is emitted can be separated from the light receiving end, and moreover, settings can be performed at various angles with respect to the direction in which the light receiving ends are aligned. Hence, even when, in the light guide unit described above, the light receiving end is arranged in, for example, the vicinity of an end that is a non-display portion of the display panel of the display device, the light emission portion emitting light can be arranged within a panel that is a display portion of the display panel (for example, can be arranged close to the vicinity of the center of the display panel).

Therefore, in the display device including the light guide unit described above, a member for shielding a light source is not necessary. Hence, the light guide unit described above is suitable for not only a display device intended for reducing the number of components but also an illumination device incorporated in a display device.

### BRIEF DESCRIPTION OF DRAWINGS

FIG. 1 An exploded perspective view of a liquid crystal display device;

FIG. 2A A cross-sectional view of the liquid crystal display device in FIG. 1 taken along line A-A′ and indicated by arrows;

FIG. 2B A cross-sectional view of the liquid crystal display device in FIG. 1 taken along line B-B′ and indicated by arrows;

FIG. 2C A cross-sectional view of the liquid crystal display device in FIG. 1 taken along line C-C′ and indicated by arrows;

FIG. 3 A perspective view of a light guide bar group in a light guide unit;

FIG. 4 A perspective view of a light guide bar of the light guide bar group;

FIG. 5A An enlarged view of the liquid crystal display device of FIG. 2C; an optical path diagram showing the optical path of light in the light guide bar;

FIG. 5B An enlarged view of the liquid crystal display device of FIG. 2B; an optical path diagram showing the optical path of the light in the light guide bar;

FIG. 6 An another example diagram of the liquid crystal display device of FIG. 2B; an optical path diagram showing the optical path of the light in the light guide bar;

FIG. 7 An another example diagram of the liquid crystal display device of FIG. 2B; an optical path diagram showing the optical path of the light in the light guide bar;

FIG. 8 An another example diagram of the liquid crystal display device of FIG. 2B; an optical path diagram showing the optical path of the light in the light guide bar;

FIG. 9 An another example diagram of the liquid crystal display device of FIG. 2B; an optical path diagram showing the optical path of the light in the light guide bar;

FIG. 10A A perspective view of the light guide bars in the light guide unit;

FIG. 10B A cross-sectional view of the light guide unit in FIG. 10A taken along line B-B′ and indicated by arrows; an optical path diagram showing the optical path of the light in the light guide bar;

FIG. 11 An another example diagram of the light guide unit of FIG. 10A; a perspective view of the light guide bar of the light guide bar group;

FIG. 12 A plan view of the light guide unit;

FIG. 13 A perspective view of the light guide bar group;

FIG. 14 A plan view of the light guide unit;

FIG. 15 An enlarged plan view of the light guide bar;

FIG. 16A A partial plan view of a light guide unit in which an arrangement distance of the light guide bars is equal to an arrangement distance of the light guide bar groups;

FIG. 16B A partial plan view of a light guide unit in which the arrangement distance of the light guide bars is different from the arrangement distance of the light guide bar groups;

FIG. 17 A plan view of the light guide unit;

FIG. 18 A plan view of the light guide unit;

FIG. 19 A perspective view of the light guide bar group in the light guide unit;

FIG. 20 A perspective view of the light guide bar in the light guide bar group;

FIG. 21A A cross-sectional view of the liquid crystal display device; an optical path diagram showing the optical path of light in the light guide bar;

FIG. 21B A cross-sectional view of the liquid crystal display device; an optical path diagram showing the optical path of light in the light guide bar;

FIG. 22 A perspective view of the light guide bar in the light guide bar group;

FIG. 23 A cross-sectional view of the liquid crystal display device including the light guide bar shown in FIG. 22; an optical path diagram showing the optical path of light in the light guide bar;

FIG. 24 A perspective view of the light guide bar in the light guide bar group;

FIG. 25 A cross-sectional view of the liquid crystal display device including the light guide bar shown in FIG. 24; an optical path diagram showing the optical path of light in the light guide bar;

FIG. 26 An another example diagram of the liquid crystal display device of FIG. 21B; an optical path diagram showing the optical path of the light in the light guide bar;

FIG. 27 An another example diagram of the liquid crystal display device of FIG. 23; an optical path diagram showing the optical path of the light in the light guide bar;

FIG. 28 A perspective view of the light guide bar in the light guide unit;

FIG. 29 A plan view of the light guide unit;

FIG. 30 A two-part diagram showing a partial plan view of the light guide unit including the light guide bar groups where the areas of processing portions differ and a brightness distribution diagram of the light guide unit;

FIG. 31 A perspective view of the light guide bar in the light guide bar group;

FIG. 32 A plan view of the light guide bar in the light guide bar group;

FIG. 33 A cross-sectional view (cross-sectional view in FIG. 32 taken along line D-D′ and indicated by arrows) of the light guide bar shown in FIG. 31;

FIG. 34 A cross-sectional view (cross-sectional view in FIG. 32 taken along line E-E′ and indicated by arrows) of the light guide bar shown in FIG. 31;

FIG. 35 A cross-sectional view of the liquid crystal display device including the light guide bar shown in FIG. 31; an optical path diagram showing the optical path of light in the light guide bar;

FIG. 36 A cross-sectional view (cross-sectional view shown for comparison) of the liquid crystal display device including the light guide bar;

FIG. 37 An another example diagram of the light guide bar of FIG. 31; a diagram showing a cross section corresponding to FIG. 33;

FIG. 38 An another example diagram of the light guide bar of FIG. 31; a diagram showing a cross section corresponding to FIG. 34;

FIG. 39 A perspective view of the light guide bar group including coupling members;

FIG. 40A A cross-sectional view of a conventional backlight unit; and

FIG. 40B A perspective view of the conventional backlight unit.

### MODE FOR CARRYING OUT THE INVENTION

### First Embodiment

An embodiment will be described below with reference to accompanying drawings. For convenience, member symbols and the like may be omitted; in that case, other drawings should be referenced. For convenience, even in drawings that are not cross-sectional views, hatching may be used. A black round that is used together with arrows means a direction perpendicular to the plane of the figure.

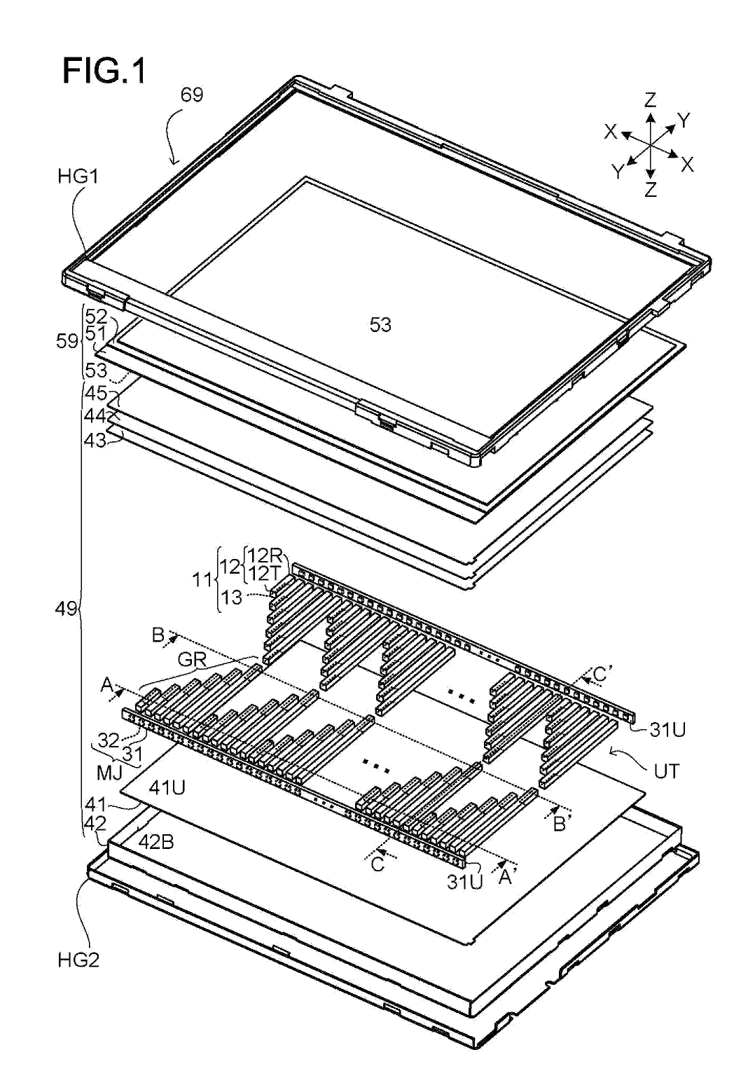

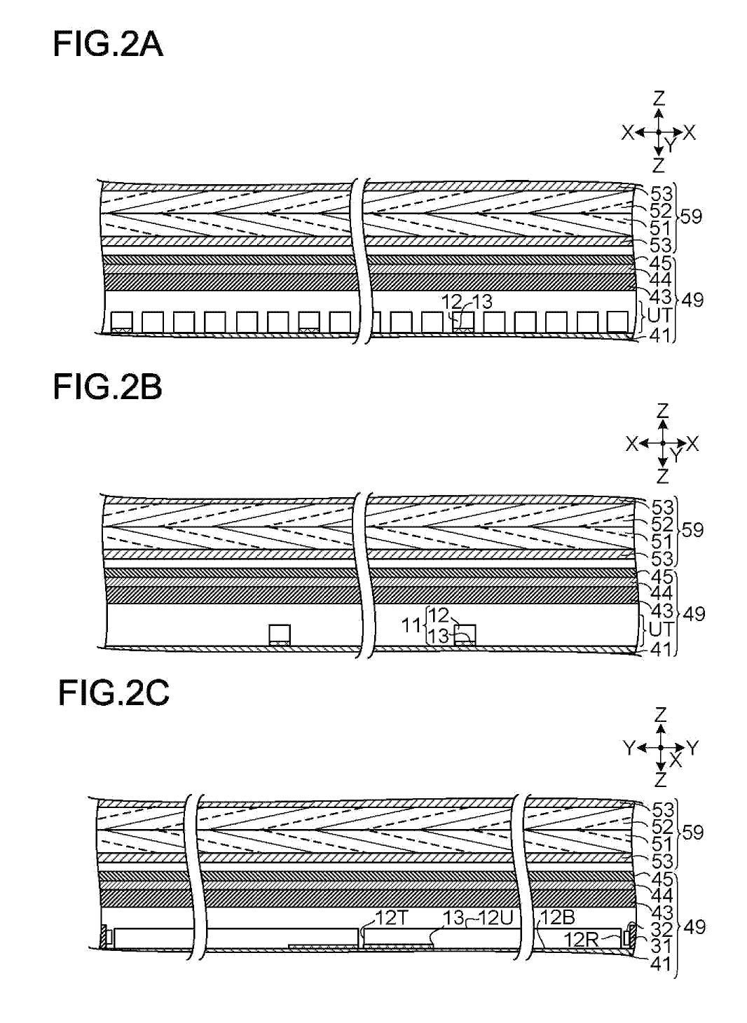

FIG. 1 is an exploded perspective view showing a liquid crystal display device 69. FIG. 2A is a cross-sectional view of the liquid crystal display device 69 in FIG. 1 taken along line A-A′ and indicated by arrows; FIG. 2B is a cross-sectional view of the liquid crystal display device 69 in FIG. 1 taken along line B-B′ and indicated by arrows; FIG. 2C is a cross-sectional view of the liquid crystal display device 69 in FIG. 1 taken along line C-C′ and indicated by arrows.

As shown in FIG. 1, the liquid crystal display device 69 includes a liquid crystal display panel (display panel) 59, a backlight unit (illumination device) 49 that supplies light to the liquid crystal display panel 59 and a housing HG (a front housing HG1 and a back housing HG2) that sandwiches these.

The liquid crystal display panel 59 is formed by adhering, with a seal member (unillustrated), an active matrix substrate 51 including switching elements such as a TFT (thin film transistor) to an opposite substrate 52 opposite the active matrix substrate 51. Then, liquid crystal (unillustrated) is injected into a gap between the substrates 51 and 52.

A polarization film 53 is attached to the side of the light receiving surface of the active matrix substrate 51, the light emitting side of the opposite substrate 52. The liquid crystal display panel 59 described above utilizes variations in transmittance resulting from the inclination of the molecules of the liquid crystal, and thereby displays an image.

The backlight unit 49 arranged directly below the liquid crystal display panel 59 will now be described. The backlight unit 49 includes an LED module (light source module) MJ, a light guide bar (light guide member) 11, a reflective sheet 41, a backlight chassis 42, a diffusion plate 43, a prism sheet 44 and a lens sheet 45.

The LED module MJ is a module that emits light, and includes a mounting substrate 31 and an LED (light emitting diode) 32 mounted on the substrate mounting surface of the mounting substrate 31.

The mounting substrate 31 is a plate-shaped and rectangular substrate; a plurality of electrodes (unillustrated) are aligned on the mounting surface 31U. The LEDs 32 are attached to the top of these electrodes. The backlight unit 49 includes two mounting substrates 31; they are arranged such that their mounting surfaces 31U are opposite each other (it is assumed that the direction in which the mounting substrate 31 extends is X direction, the direction in which the two mounting substrates 31 are aligned is Y direction and the direction perpendicular to the X direction and the Y direction is Z direction).

The LEDs 32 are mounted on the electrodes (unillustrated) formed on the mounting surface of the mounting substrate 31, and thus receive the supply of current to emit light. In order for a sufficient amount of light to be acquired, a plurality of LEDs (light emitting elements, point light sources) 32 are preferably mounted on the mounting substrate 31. For convenience, only part of the LEDs 32 are shown in the drawing.

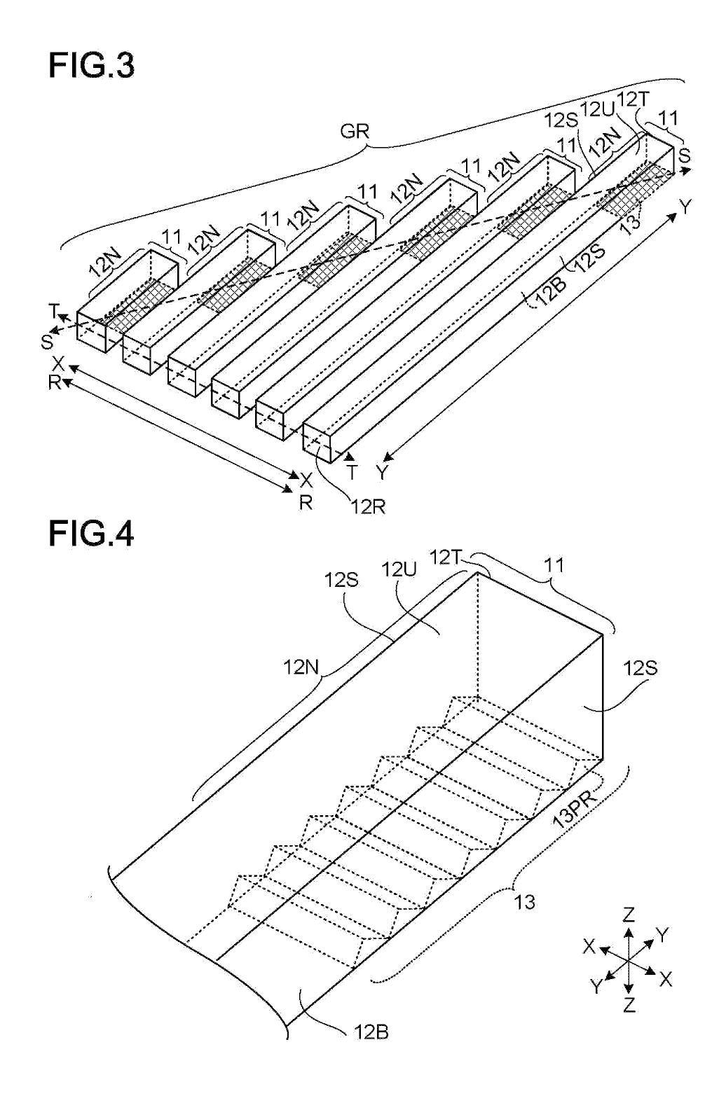

The light guide bar 11 is a bar-shaped member that is formed of a material that is a transparent resin such as an acrylic resin or polycarbonate, and receives light from the LEDs 32 to introduce the light therewithin (to guide the light). Specifically, as shown in FIG. 3 and FIG. 4 (which is an enlarged view of FIG. 3), the light guide bar 11 is a rectangular parallelepiped-shaped light guide material that extends in the Y direction; the light guide bars 11 are aligned closely along the X direction (a group of a plurality of light guide bars 11 are referred to as a light guide bar group GR).

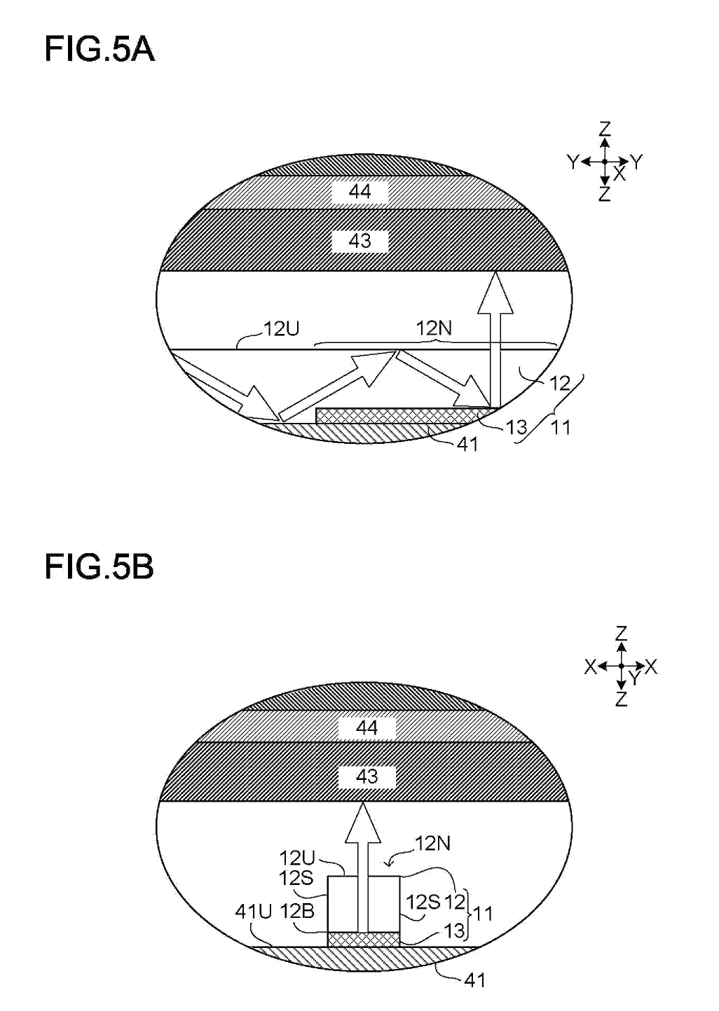

In the light guide bar 11, one end in the length direction is assumed to be a light receiving end 12R that receives the light from the LEDs 32, and the other end in the length direction, that is, the end on the opposite side of the light receiving end 12R, is assumed to be a top end 12T (in the light guide bar group GR of FIG. 3, the light guide bars 11 having different lengths are arranged closely). As shown in FIG. 5A which is an enlarged view of FIG. 2C, the light guide bar 11 reflects the received light (see white arrows) multiple times therewithin, and thereby propagates the light from the light receiving end 12R to the top end 12T (the portion through which the light is propagated is referred to as a light propagation portion 12).

Furthermore, the light guide bar 11 includes a processing portion 13 that changes the light propagated therewithin into an optical path suitable for emission to the outside (in short, that changes the optical path such that the light can be emitted from a side surface 12S of the light guide bar 11 without total reflection). This processing portion (optical path change processing portion) 13 is a surface that is completed by aligning triangular prisms 13PR in the Y direction in the side of the top end 12T of the light guide bar 11, for example, as shown in FIG. 4.

The processing portion 13 is not limited to the prism processing portion 13 where the triangular prisms 13PR are arranged closely; the processing portion 13 may be a portion, other than the prism processing portion 13, where a fine shape is processed, a portion that has been subjected to a dot-type printing processing or the like (the processed surface is parallel to an arrangement plane direction (an X-Y plane direction specified by the X direction and the Y direction) in which a plurality of light guide bars 11 are aligned). The portion where the fine shape is processed is preferably a portion (prism processing portion) that has been subjected to prism processing, a portion that has been subjected to grain processing or the like; it may be a portion other than those portions.

The portion where the fine shape is processed (for example, the portion that has been subjected to the prism processing, the portion that has been subjected to the grain processing or the like) reflects or refracts and transmits the light to change the direction of travel of the light, prevents the light from being totally reflected by the side surface 12S of the light guide bar 11 and thereby emits the light to the outside. The portion that has been subjected to the dot-type printing processing is formed of, for example, white ink, diffuses or reflects the light to change the direction of travel of the light, prevents the light from being totally reflected by the side surface 12S of the light guide bar 11 and thereby emits the light to the outside (a portion of the light propagation portion 12 that includes the processing portion 13 and that overlaps the processing portion 13 is referred to as a light emission portion 12N).

As shown in FIG. 5B which is an enlarged view of FIG. 2B, the processing portion 13 refracts the light at an emission angle different from an incident angle of the received light and makes the light travel (in short, changes the angle of refraction of the propagated light; see a white arrow), and thereby makes the light incident on one surface of the light guide bar 11 at an angle less than a critical angle and emits the light to the outside (the critical angle is a critical angle specific to the light guide material). Then, light beams emitted from a plurality of light guide bars 11 overlap each other, and thus planar light is produced.

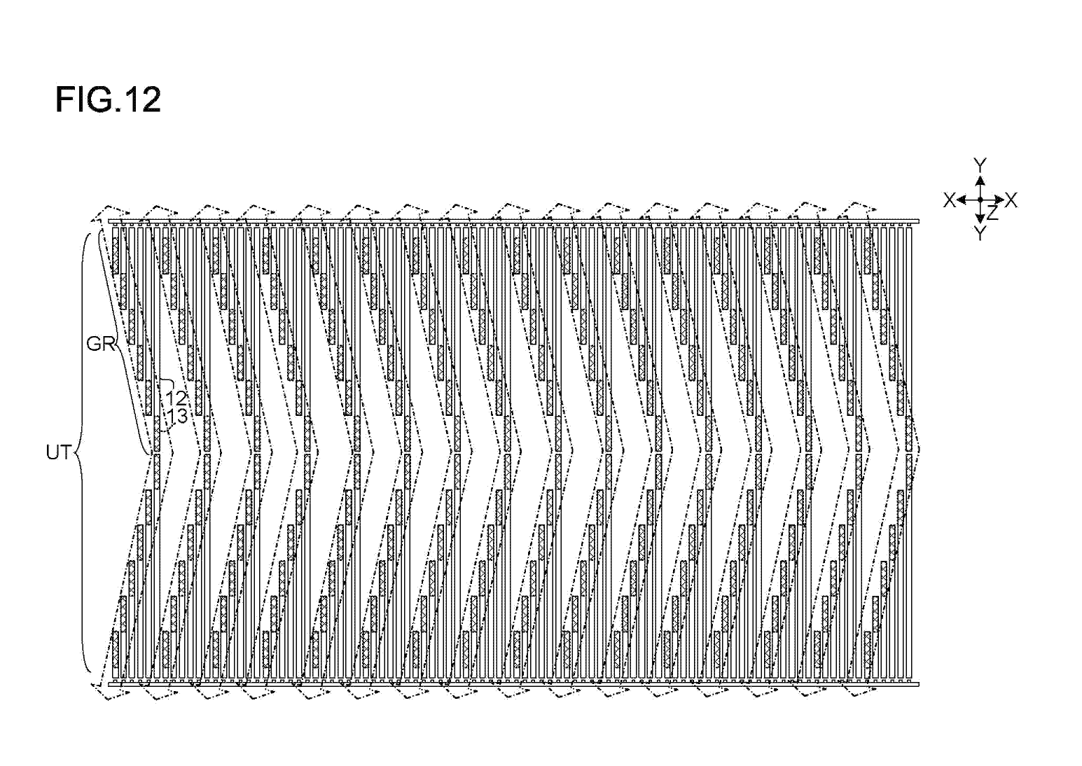

A plurality of light guide bar groups GR where the light guide bars 11 which guide the light from the LEDs 32 as described above are placed, are aligned as shown in FIG. 3. Specifically, in the light guide bar group GR, the light guide bars 11 having different lengths (for example, whose lengths are gradually increased) are aligned from one side to the other side in the X direction, and furthermore, a plurality of light guide bar groups GR are repeatedly arranged along one mounting substrate 31 while facing in the same direction (see FIG. 12, which will be described later). Since the LEDs 32 are mounted along the X direction that is the direction in which the mounting substrate 31 extends, in the light guide bar group GR, the light receiving ends 12R are also aligned along the X direction (a line that is formed by connecting the positions of the light receiving ends 12R is referred to as a light receiving end arrangement line T or a T direction).

A combination of the light guide bar groups GR aligned along one mounting substrate 31 and the light guide bar groups GR aligned along the other mounting substrate 31 has a line-symmetrical arrangement. In the following description, a set of light guide bar groups GR is referred to as a light guide unit UT (the number of light guide bar groups GR included in the light guide unit UT is not limited to two or more; it may be one).

The reflective sheet 41 is a sheet that is covered by the bottom surfaces 12B (each of which is one of the four side surfaces 11S of the light guide bar 11) of a plurality of light guide bars 11; a reflective surface 41U of the sheet faces the bottom surfaces 12B of the light guide bars 11. When light leaks from the bottom surfaces 12B of the light guide bars 11, the light is reflected to return to the light guide bars 11, and thus the loss of the light is prevented.

As shown in FIG. 1, the backlight chassis 42 is, for example, a box-shaped member; the LED modules MJ and the light guide unit UT are placed over a bottom surface 42B, and thus they are held.

The diffusion plate 43 is an optical sheet that covers the light guide unit UT, and diffuses light emitted from the light guide unit UT. Specifically, the diffusion plate 43 diffuses the planar light (in short, the light from the light guide unit UT) that is formed by overlapping light from a plurality of light guide bars 11, and thereby spreads the light over the entire liquid crystal display panel 59.

The prism sheet 44 is an optical sheet that covers the diffusion plate 43. In the prism sheet 44, for example, triangular prisms extending in one direction (linearly) are aligned within the sheet surface in a direction intersecting the one direction. In this way, the prism sheet 44 changes the emission characteristic of light from the diffusion plate 43.

The lens sheet 45 is an optical sheet that covers the prism sheet 44. In the lens sheet 45, minute particles that refract and scatter light are dispersed therewithin. In this way, the lens sheet 45 prevents the light from the prism sheet 44 from being locally collected, and thus contrast (variations in the amount of light) is reduced.

In the backlight unit 49 described above, the light from a plurality of LED modules MJ is changed into the planar light by the light guide unit UT, and the planar light is made to pass through a plurality of optical sheets 43 to 45, and is supplied to the liquid crystal display panel 59. In this way, the liquid crystal display panel 59 that does not emit light receives the light (backlight) from the backlight unit 49, and enhances the display function.

The light guide unit UT will now be described in detail. In the light guide bar groups GR of the light guide unit UT, as shown in FIG. 3, the light guide bars 11 having different lengths are included. In the side of the top ends 12T of the light guide bars 11, the processing portions 13 are formed (in all the processing portions 13, the lengths in the X direction and the lengths in the Y direction are equal to each other).

Then, the processing portions 13 are not aligned along the X direction, and are aligned to intersect the X direction (that is, the direction in which the light guide bars 11 are aligned; referred to as a R direction). Specifically, as shown in FIG. 3, in the light guide bar group GR, a light emission portion arrangement line S that is formed by connecting the positions of the processing portions 13, that is, the positions of the light emission portions 12N including the processing portions 13 intersects the X direction (in other words, the light receiving end arrangement line T).

In this configuration, even when the light receiving ends 12R of the light guide unit UT are arranged in the vicinity of an end of the liquid crystal display panel 59 of the liquid crystal display device 69 that is a non-display portion (for example, the perimeter of the liquid crystal display panel 59), the light emission portions 12N that emit light are arranged within the interior of the panel that is a display portion of the liquid crystal display panel 59 (for example, are arranged close to the center of the display channel). Therefore, when the light guide unit UT is incorporated in the backlight unit 49 and hence in the liquid crystal display device 69, for example, it is unnecessary to use a member for hiding the LEDs 32.

Since such a member is not present, the light of the light guide bar 11 emitted from the light emission portion 12N travels in a desired direction without the travel of the light being disturbed, with the result that loss is not produced. Therefore, when the light guide unit UT is incorporated in the backlight unit 49, the efficiency of the utilization of the light is enhanced, and furthermore, the cost of the backlight unit 49 and hence the liquid crystal display device 69 and the like is reduced.

Moreover, in the light guide unit UT described above, the positions of the light emission portions 12N that emit light are not arranged close to each other, and are scattered appropriately. Hence, the following problem is prevented: for example, the light from the light emission portions 12N is locally collected, and do not spread to the other portions, with the result that planar light having variations in the amount of light is generated (in shirt, the light from the light guide bars 11 is not separated but is overlapped, and thus the broad planar light is produced). Therefore, the backlight unit 49 incorporating the light guide unit UT supplies high-quality backlight (planar light) to the liquid crystal display panel 59.

Since the size of the light guide unit UT is increased by further arranging, close to each other, the light guide bar groups GR that are the aggregations of the relatively small light guide bars 11, it is possible to acquire the amount of light suitable for a large backlight unit 49 (in short, the number of light guide bars 11 is changed, and thus it is possible to change the size of the light guide unit UT and the amount of light emitted by the light guide unit UT).

Although, for example, when one sheet-shaped light guide plate is used, a manufacturing mold needs to be changed according to the display area of the liquid crystal display panel 59 (that is, the display area of the liquid crystal display panel 59), in the light guide unit UT, it is possible to cope with the change in the display area of the liquid crystal display device 69 by changing the number of the light guide bars 11 or the light guide bar groups GR without the manufacturing mold being changed. Thus, although the cost of the light guide unit UT is reduced, it can be further applied to various types of devices.

Since, in the light guide unit UT, light is not exchanged between the light guide bars 11, it is possible to control the emission of light for each of the light guide bars 11. The emission of light is controlled according to the light guide bars 11 of the light guide unit UT. Hence, the light guide unit UT can be said to be suitable member for local dimming control (technology for partially controlling the amount of planar backlight).

As shown in FIG. 3, in the light guide bar group GR, the light guide bars 11 have a plurality of different lengths. However, the present invention is not limited to this configuration. For example, among six light guide bars 11 of the light guide bar group GR, two or more but less than six light guide bars 11 having the same length may be included. This is because, when the light guide bars 11 having at least two different lengths are included, in the light guide bar group GR, it is possible to prevent light from being aligned (close to each other) in the direction in which the light receiving ends 12R are arranged.

Specifically, when a large number of light guide bars 11 having different lengths are included in the light guide bar group GR, for example, only by aligning the light receiving ends 12R of the light guide bars 11 in one row, the positions (that is, the positions of the processing portions 13) that emit light from the light guide bars 11 to the outside are not aligned along the direction in which the light receiving ends 12R are aligned and are scattered. Hence, the light guide unit UT easily guides the light in a direction intersecting the direction (X direction) in which the light receiving ends 12R are aligned. The length of the light guide bar 11 is appropriately changed, and thus the distribution of the amount of light in the liquid crystal display panel 59 is easily changed.

As shown in FIGS. 3 and 5B, the processing portion 13 is planar, and a planar direction thereof is parallel to the arrangement plane direction (the X-Y plane direction) in which a plurality of light guide bars 11 are aligned (when the light receiving side of the processing portion 13 faces the diffusion plate 43, the bottom surface 12B that is one surface of the side surfaces 12S where the processing portion 13 is formed is the farthest away from the diffusion plate 43 as compared with the other side surface 12S). However, the plane direction of the processing portion 13 may intersect the XY plane direction (the plane direction of the reflective surface 41U).

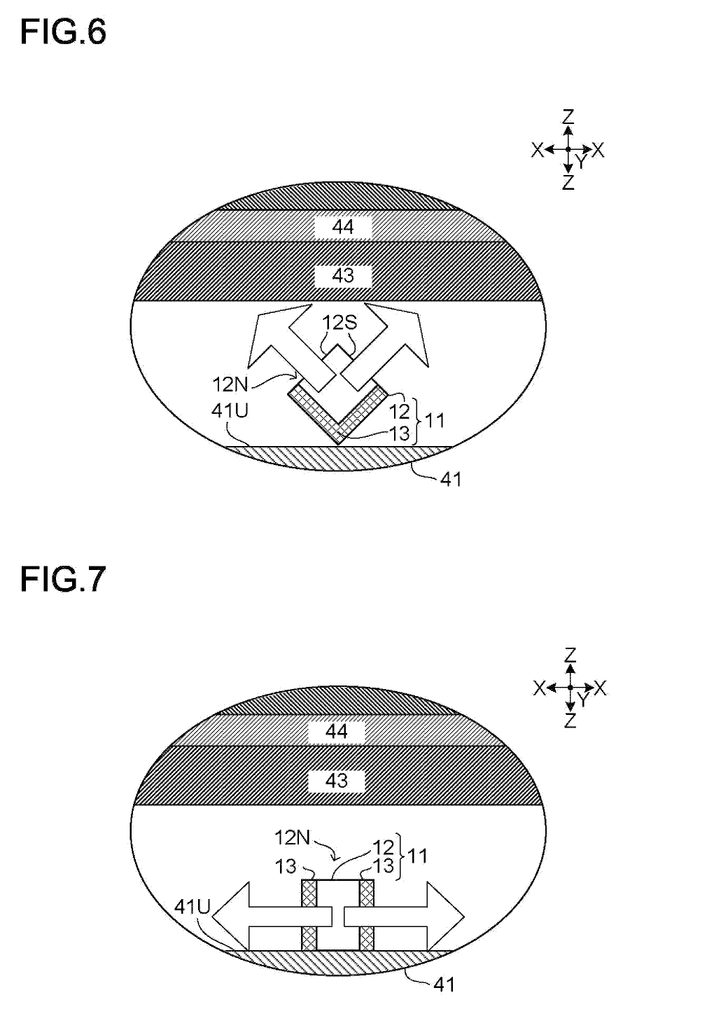

For example, when the processing portion 13 is formed in two continuous surfaces of the side surfaces 12S of the bar-shaped light guide bar 11, as shown in FIG. 6, the side surfaces 12S where the processing portions 13 are formed are separate from the reflective surface 41U, and the connection of the two side surfaces 12S is preferably arranged to face the reflective surface 41U (when the light receiving side of the processing portion 13 faces the diffusion plate 43, the two side surfaces 12S where the processing portions 13 are formed are the farthest away from the diffusion plate 43 as compared with the other side surfaces 12S).

In this configuration, the light of FIG. 6 (see white arrows) has a long optical path from the processing portion 13 to the diffusion plate 43 as compared with the light of FIG. 5B. In the case where the optical path is long, when the widths of the light beams shone on the diffusion plate 43 are compared with each other, the width of the light beam of FIG. 6 is increased as compared with the width of the light beam of FIG. 5B. Consequently, the planar light shone on the diffusion plate 43 becomes light that is obtained by overlapping the light from a plurality of light guide bars 11 in a wide range and that has no variations in the amount of light, and the quality of the backlight is enhanced (in the liquid crystal display device 69 shown in FIGS. 5B and 6, the distance from the diffusion plate 43 to the processing portion 13 of the light guide bar 11 is longer than the distance from the reflective sheet 41 to the processing portion 13).

Preferably, when, as shown in FIG. 7, the processing portion 13 is formed on two surfaces that are separate (face each other) among the side surfaces 12S of the bar-shaped light guide bar 11, the side surfaces 12S where the processing portions 13 are formed are arranged to intersect the reflective surface 41U of the reflective sheet 41 and the side surface 12S where no processing portion 13 is formed makes contact with the reflective surface 41U. Even in this configuration, the planar light shone on the diffusion plate 43 becomes light that is obtained by overlapping the light from a plurality of light guide bars 11 in a wide range and that has no variations in the amount of light, and the quality of the backlight is enhanced.

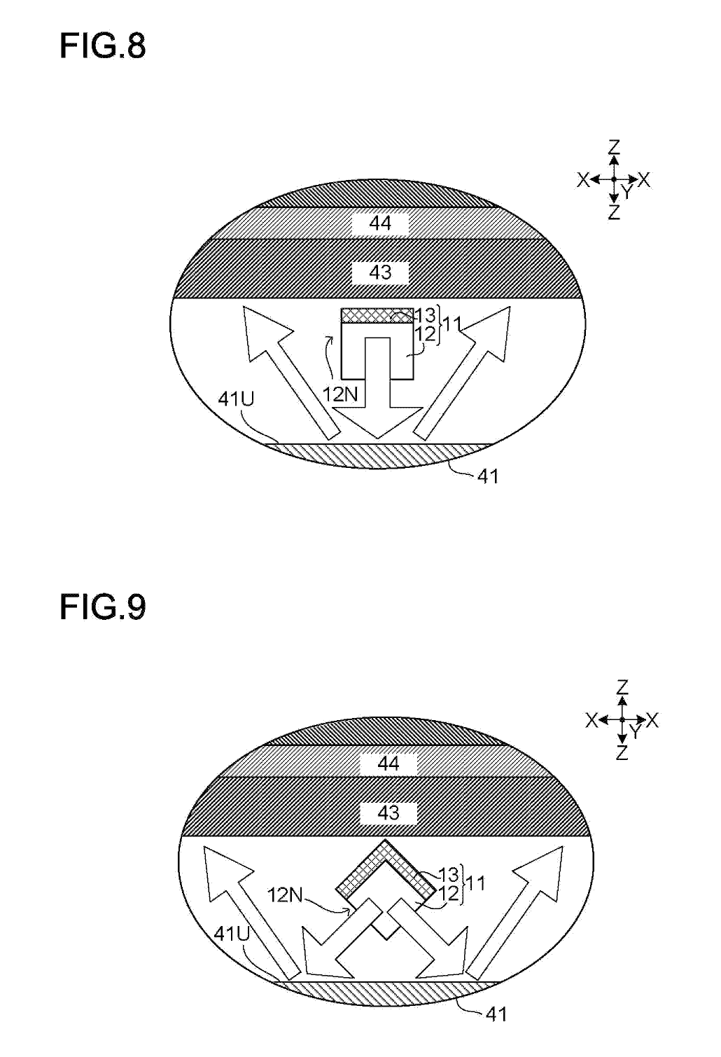

As shown in FIG. 8, the processing portion 13 may be planar, and the light receiving side (the light receiving surface) of the surface may face the reflective sheet 41 (specifically, the reflective surface 41U) (when the light receiving side of the processing portion 13 faces the reflective sheet 41, one surface of the side surfaces 12S where the processing portion 13 is formed is the farthest away from the reflective sheet 41 as compared with the other side surfaces 12S). In this configuration, the light of FIG. 8 (see white arrows) travels from the processing portion 13 to the reflective sheet 41, is reflected off the reflective sheet 41 and then reaches the diffusion plate 43. Hence, the optical path extending from the processing portion 13 to the diffusion plate 43 is reliably made longer.

Moreover, when the distance from the reflective sheet 41 to the processing portion 13 of the light guide bar 11 is longer than the distance from the diffusion plate 43 to the processing portion 13, the optical path of the light from the processing portion 13 is more reliably made longer. Hence, the planar light shone on the diffusion plate 43 becomes light that is obtained by overlapping the light from a plurality of light guide bars 11 in a wide range and that has no variations in the amount of light, and the quality of the backlight is enhanced.

Preferably, when the surface (the light receiving surface) of the processing portion 13 faces the reflective sheet 41, the distance from the reflective sheet 41 to the processing portion 13 of the light guide bar 11 is longer than the distance from the diffusion plate 43 to the processing portion 13 and, as shown in FIG. 9, the processing portions 13 are formed in two continuous surfaces among the side surfaces 12S of the bar-shaped light guide bar 11, the two side surfaces 12S where the processing portions 13 are formed are separate from the diffusion plate 43 of the reflective sheet 41, and the connection of the two side surfaces 12S is arranged to face (close to) the diffusion plate 43 (when the light receiving side of the processing portion 13 faces the reflective sheet 41, the two side surfaces 12S where the processing portions 13 are formed are the farthest away from the reflective sheet 41 as compared with the other side surfaces 12S). This because, even in this configuration, the optical path from the processing portion 13 to the diffusion plate 43 is reliably made longer.

In short, when the light guide bar 11 is bar-shaped, the processing portion 13 is preferably formed in at least one of the side surfaces 12S of the bar (see FIGS. 5B and 6 to 9). In this configuration, the direction of emission of the light is easily changed according to the position of the side surface 12S where the processing portion 13 is formed. The bar-shaped light guide bar 11 is only inclined (rotated in the Y direction), and thus it is possible to easily change the direction of emission of the light from the light guide bar 11 and to extend the optical path from the processing portion 13 to the diffusion plate 43.

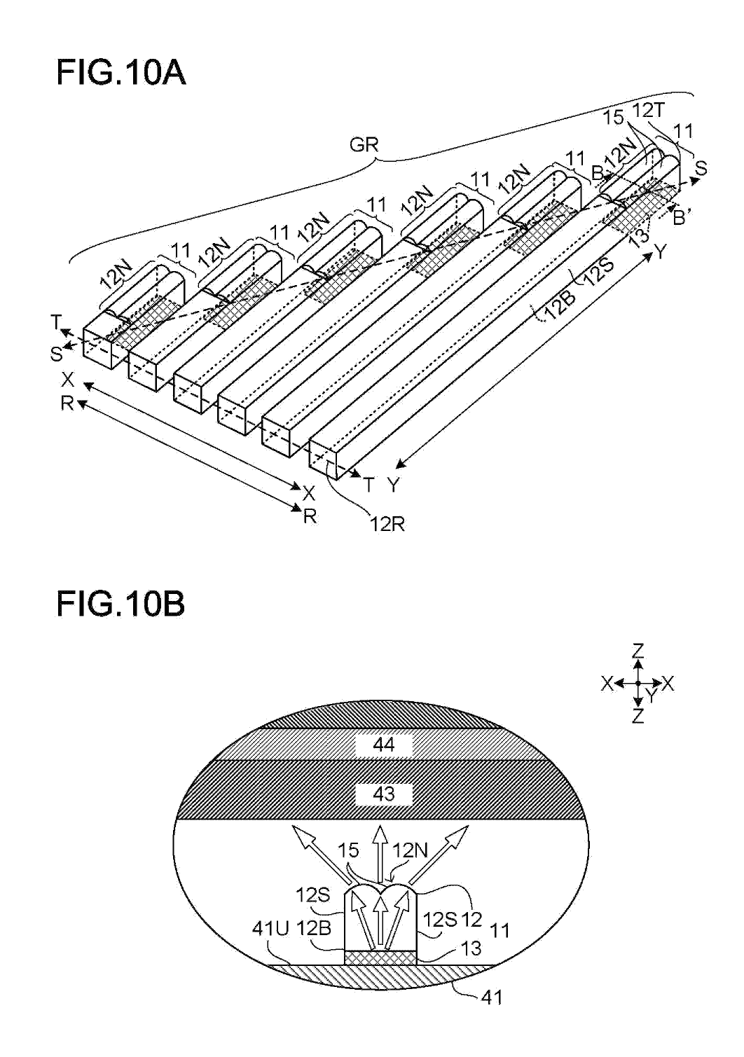

As shown in FIGS. 10A and 10B (a cross-sectional view taken along line B-B′ of FIG. 10A and indicated by arrows), a lens 15 that diffuses the light from the processing portion 13 may be formed in the side surface 12S (also referred to as a top surface 12U) of the light guide bar 11 opposite the processing portion 13 of the light guide bar 11. For example, two cylindrical lenses 15 may be formed in the top surface 12U of the light guide bar 11 (the shape of the cylindrical lens 15 is semicircular in the cross-sectional view along the XZ plane direction specified by the X direction and the Z direction).

In this configuration, the light travelling from the processing portion 13 is diffused by passing through the lenses (diffusion lenses) 15, and is emitted to the outside. Hence, for example, when the light enters the diffusion plate 43 that is arranged to cover the lenses 15, the width of the light beam of the light is increased. In this way, the application area of the diffusion plate 43 to which the light is applied is increased, and a large number of application areas overlap each other, with the result that backlight having no variations in the amount of light is produced.

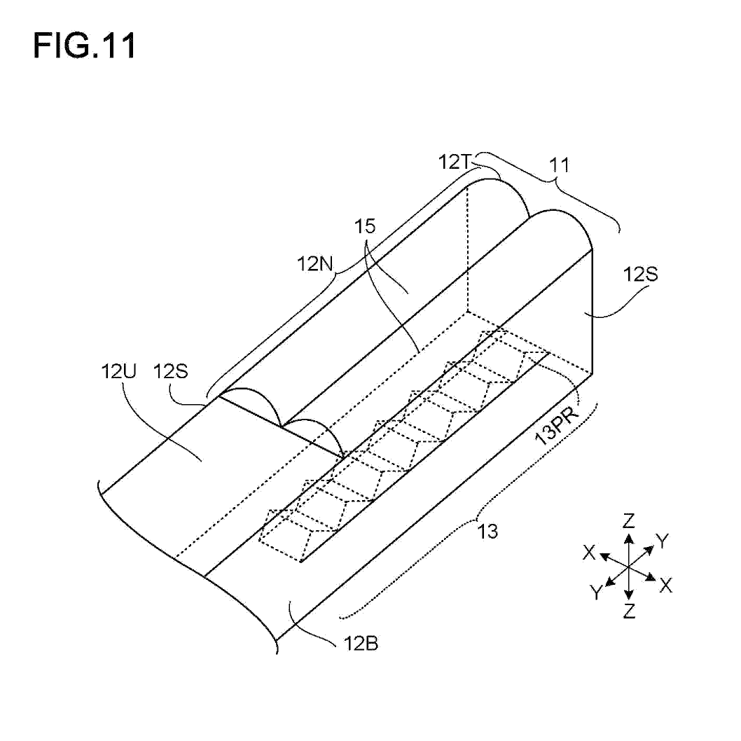

Preferably, in the light guide bar 11 including the lenses 15 described above, as shown in FIG. 11, the processing portion 13 is not formed in the entire bottom surface 12B (one of the side surfaces 12S of the light guide bar 11, that is, the opposite surface of the top surface 12U) of the light guide bar 11 in the width direction (the X direction), and is formed only around the center of the width (in shirt, preferably, the processing portion 13 in the bottom surface 12B sandwiched between the side surfaces 12S aligned in the width direction of the light guide bar 11 is formed to be separate from those side surfaces 12S).

This is because, even if the light enters parts of the lens surface close to the side surfaces 12S sandwiching the top surface 12U, since the curvature of the lenses 15 is low, it is difficult to diffuse the light. The processing portions 13 close to the side surfaces 12S that are more likely to guide the light to the lens surface close to the side surfaces 12S sandwiching the top surface 12U may be omitted. In this configuration, the processing cost of the processing portion 13 is reduced.

The above description has a discussion that the optical path of the light from the LEDs 32 is extended as much as possible, thus the degree to which the light is mixed is increased (in short, the length of the optical path is increased to increase the size of the light beams and thus the light beams as large as possible are overlapped) and the high-quality planar light is produced. However, needless to say, in the backlight unit 49 in which the light guide bars 11 are used, the optical path can be extended as compared with a direct type backlight unit in which light is made to directly enter a diffusion plate from LEDs. Hence, the backlight unit 49 incorporating the light guide unit UT can supply the high-quality backlight.

Moreover, although, in the direct type backlight unit, the distance from the LEDs to the diffusion plate needs to be increased so as to increase the degree to which the light is mixed, the backlight unit 49 incorporating the light guide unit UT does not need it. Hence, since the distance from the diffusion plate 43 to the processing portion 13 is relatively small, the thickness of the backlight unit 49 is reduced.

### Second Embodiment

A second embodiment will be described. Members that have the same functions as those used in the first embodiment are identified with like symbols, and their description will not be repeated.

As shown in the plan view of FIG. 12, in the light guide unit UT of the backlight unit 49 of the first embodiment, the light guide bar groups GR are arranged symmetrically, and the direction (the Y direction) of the length of the light guide bar 11 is perpendicular to the direction (the X direction) in which the receiving ends 11R of the light guide bars 11 are aligned.

Hence, in the light guide bar groups GR opposite each other along the Y direction, the path obtained by connecting the light from the processing portions 13 (hence, the light emission portions 12N) arranged in the side of the top ends 12T of the light guide bars 11 is, as shown in FIG. 12, formed in the shape of a broken line (V-shaped) indicated by the arrows of alternate long and short dashed lines. When two light guide bar groups GR opposite each other are aligned along the X direction, the broken-line-shaped paths of the light are also aligned along the X direction.

Then, the light from the backlight unit 49 (that is, the light guide unit UT) is slightly displaced to the side of the bending point of the broken line; if the degree to which it is displaced is excessive, the backlight is likely to have variations in the amount of light. Since the broken-line-shaped path of the light is not parallel to the longitudinal direction and the width direction of the liquid crystal display panel 59, as a line of light (variations in the amount of light), it is likely to become noticeable in terms of visual characteristics.

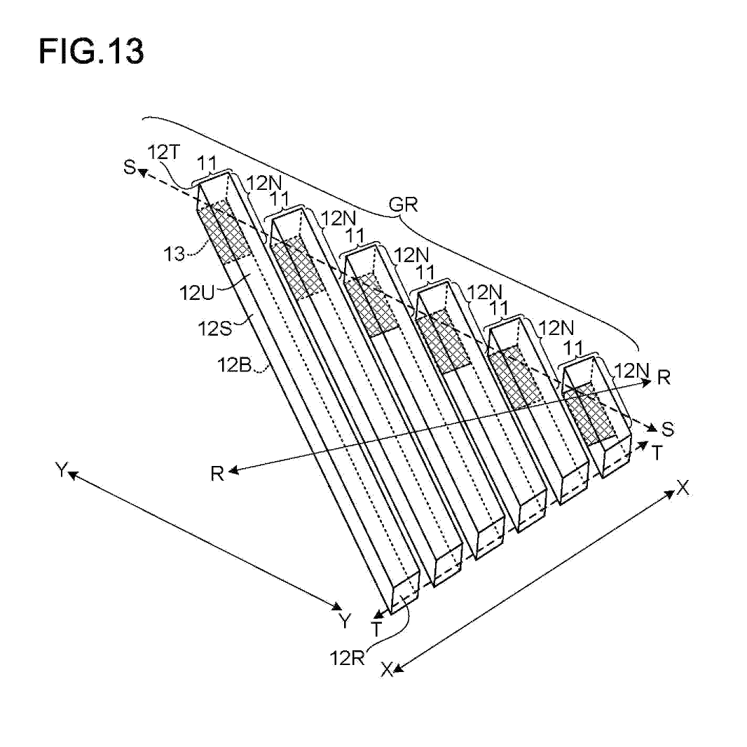

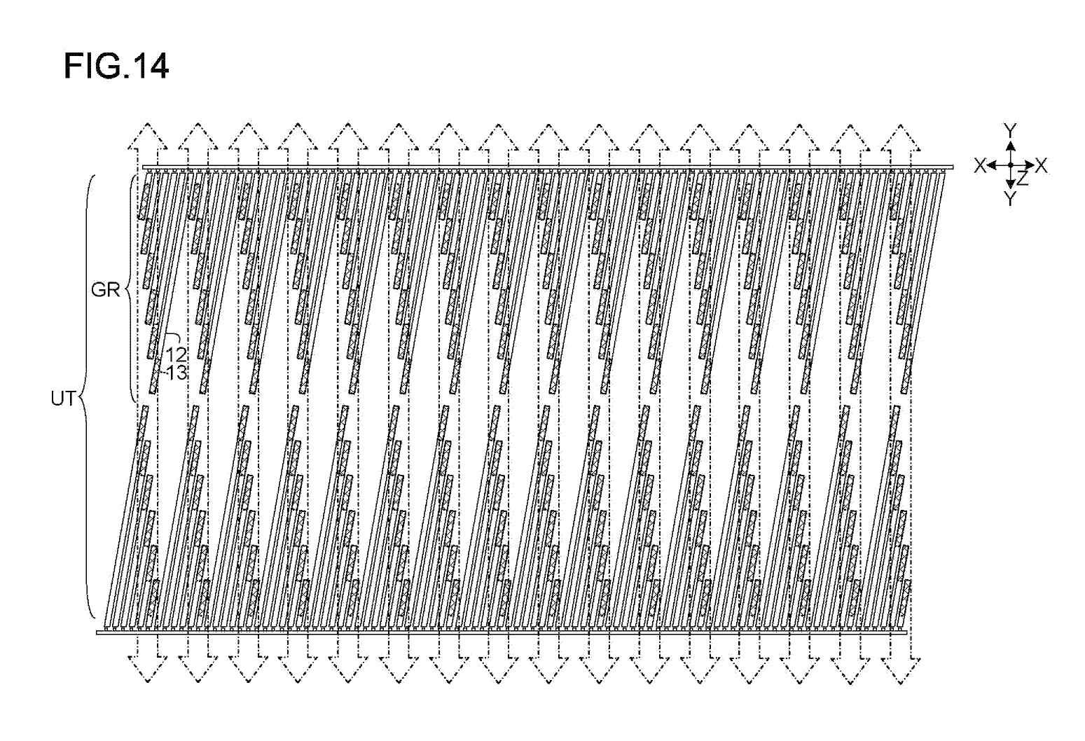

Hence, preferably, as shown in the perspective view of FIG. 13, in the light guide bar group GR, the light receiving end arrangement line T formed by connecting the positions of the light receiving ends 12R intersects the R direction in which the light guide bars 11 are aligned and is perpendicular to the light emission portion arrangement line S formed by connecting the processing portions 13. For example, the light guide bars 11 having different lengths (for example, the length is gradually increased) are aligned such that the light receiving ends 12R are along the X direction. Furthermore, as shown in the plan view of FIG. 14, in each of the mounting substrates 31, the light guide bar groups GR are repeatedly arranged in the same direction from one side to the other side in the X direction; the light guide unit UT has a point-symmetrical arrangement.

Since, in this configuration, as shown in FIG. 14, the light (see the arrows of alternate long and short dashed lines) of the backlight unit 49 incorporating the light guide unit UT is not displaced, the backlight is unlikely to have variations in the amount of light. Moreover, when the light from the backlight unit 49 is supplied to the liquid crystal display panel 59, the light is along the Y direction that is the width direction of the liquid crystal display panel 59. Hence, the user can easily see the liquid crystal display panel 59 in terms of visual characteristics (the change of the arrangement of the light guide unit UT can cause the light from the backlight unit 49 to be along the X direction that is the longitudinal direction of the liquid crystal display panel 59).

The light guide unit UT shown in FIG. 14 is provided on the condition that the light emission portion arrangement line S where the processing portions 13 guiding light are continuous is straight. In other words, the arrangement of the light guide bar groups GR in which the light emission portion arrangement line S is straight is changed in various ways, and thus it is possible to assembly either the light guide unit UT shown in FIG. 14 or the light guide unit UT shown in FIG. 12. Hence, the light guide unit UT including the light guide bar groups GR in which the light emission portion arrangement line S is straight can be said to be suitable for the liquid crystal display device 69.

Incidentally, when the light enters the light receiving end 12R of the light guide bar 11, in the process of the light travelling toward the top end 12T, it is desirable to prevent the light from being emitted as much as possible from the light guide bar 11 (in short, it is desirable to reduce the decrease in the amount of light that reaches the processing portion 13). In particular, as shown in FIG. 13, when, in the light guide bar 11, the side surface 12S is not perpendicular to the flat surface (the light receiving surface) of the light receiving end 12R, the light travelling from the light receiving end 12R to the top end 12T is likely to be emitted from the side surface 12S.

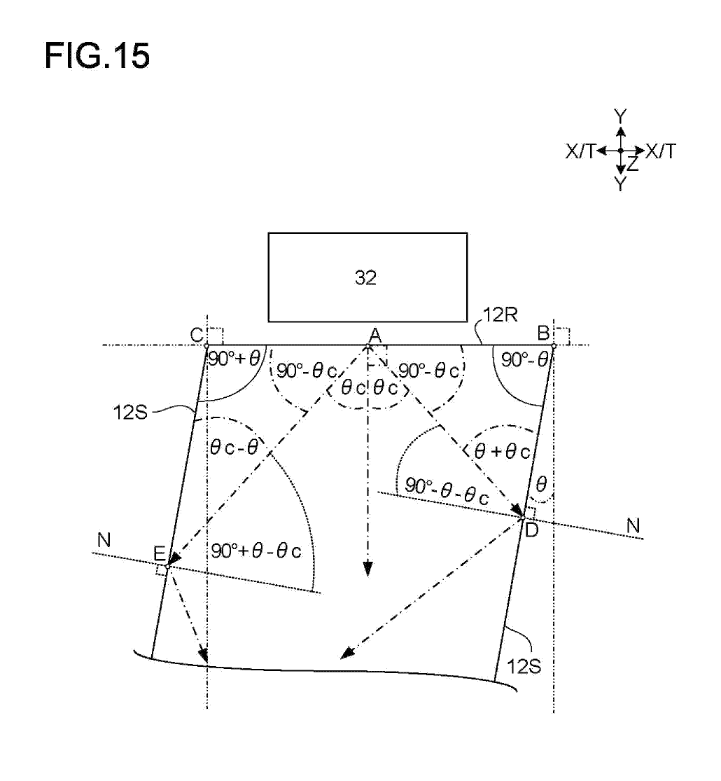

In order for this problem to be solved, an inclination angle (θc°) of the side surface 12S is preferably set such that a relational formula reflecting the critical angle) (θc°) of the material of the light guide bar 11 is satisfied (see FIG. 15). The inclination angle refers to an angle that is formed with respect to the Y direction by at least part of the side surface 12S (specifically, the inside surface or the outside surface of the side surface 12S), for example, part of the side surface 12S which overlaps a TY plane specified by the T direction in which the light receiving ends 12R are aligned and the Y direction.

Here, a detailed description will be given with reference to FIG. 15, which is an enlarged plan view of the light guide bar 11. In the figure, the arrows of alternate long and short dashed lines mean light, and dashed lines N mean normals to the side surface 12S.

In general, when the light enters the flat surface of the light receiving end 12R, the light does not have a refraction angle equal or more than the critical angle) (θc°) with respect to the flat surface of the light receiving end 12R (it is assumed that the light receiving point of the light receiving end 12R is A point, and that one of both ends of the light receiving end 12R overlapped by the TY plane overlapping the A point is B point and the other end is C point).

Then, when the light is incident on the side surface 12S including the B point, and the incident point of the side surface is assumed to be D point, an angle ABD, an angel BDA and an angle DAB are determined. Specifically,

angle ABD=90°−θ

angle BDA=θ+θc and

angle DAB=90°−θc.

Then, the incident angle of the light with respect to the side surface 12S including the B point becomes 90°−θ−θc. Preferably, in order for the light not to pass through the side surface 12S including the B point and exit to the outside, at the incident angle (90°−θ−θc) that is larger than the critical angle, total reflection is made to occur. That is, the following relational formula A is derived from 90°−θ−θc≧θc.

θ≦90°−2×θc (Relational formula A)

When the light is incident on the side surface 12S including the C point, and the incident point of the side surface 12S is assumed to be E point, the angle ABD, the angel BDA and the angle DAB are determined. Specifically,

angle ACE=90°+θ

angle CEA=θc−θ and

angle EAC=90°−θc.

The incident angle of the light with respect to the side surface 12S including the C point becomes 90°+θ−θc. The incident angle (90°θ−θc) is prevented from being smaller than the critical angle. Hence, the light with respect to the side surface 12S including the C point is totally reflected.

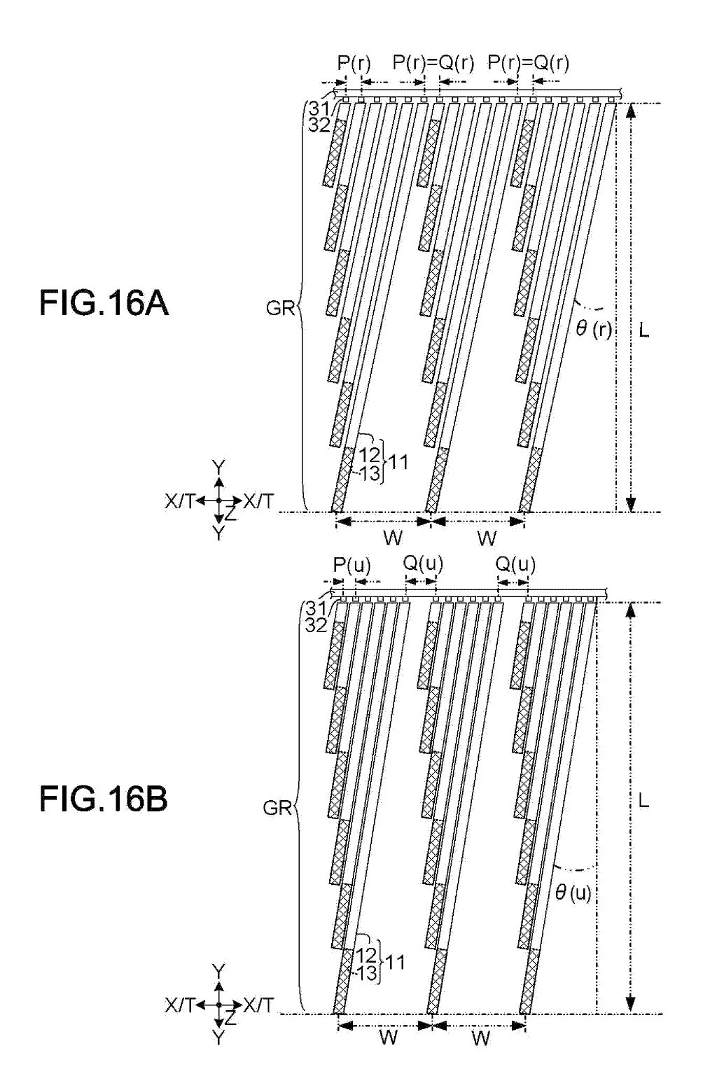

As shown in FIG. 16A, it is assumed that an arrangement distance between the light guide bars 11 of the light guide bar group GR is an arrangement distance P, that a length from the light receiving end 12R of the light guide bar 11 having the shortest length to the top end 12T of the light guide bar 11 having the longest length is length L (where the line having this length is parallel to the Y direction), that the number of light guide bars 11 of the light guide bar group GR is m and that the inclination angle of the side surface 12S of the light guide bar 11 is θ, the following relational formula B can be derived (for convenience, θ of FIG. 15A may be referred to as θ (r), and the arrangement distance P may be referred to as P (r)).

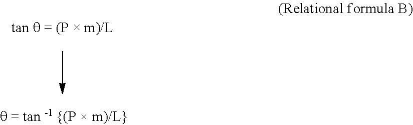

In FIG. 16A, as in FIG. 14, the arrangement distance P(r) between the light guide bars 11 of the light guide bar group GR is equal to the arrangement distance Q(r) of the light guide bar group GR. However, the present invention is not limited to this arrangement. For example, the light guide unit UT as shown in FIG. 16B is possible.

For example, when the arrangement distance W of the light guide bar group GR is equal to the length L both in the light guide unit UT of FIG. 16A and in the light guide unit UT of FIG. 16B, as shown in FIG. 16B, the arrangement distance P(u) between the light guide bars 11 of the light guide bar group GR may be shorter than the arrangement distance P(r) between the light guide bars 11 of FIG. 16A {P(u)<P(r)}, and the arrangement distance Q(u) of the light guide bar group GR may be longer than the arrangement distance Q(r) of the light guide bar group GR of FIG. 16A {Q(u)>Q(r)}.

Then, when FIG. 16A and FIG. 16B are compared, in the light guide unit UT as shown in FIG. 16A, the relational formula B is as follows.

θ(r)=tan⁻¹{(P(r)×m)/L} (Relational formula Ba)

On the other hand, in the light guide unit UT as shown in FIG. 16B, the relational formula B is as follows.

θ(u)=tan⁻¹{(P(u)×m)/L} (Relational formula Bb)

θ(u)<θ(r) is given by the relationship P(u)<P(r). In other words, when, in the light guide unit UT, a predetermined arrangement distance W of the light guide bar group GR and a predetermined length L (the length from the light receiving end 12R of the light guide bar 11 having the shortest length to the top end 12T of the light guide bar 11 having the longest length) are fixed, as shown in FIG. 16B, the arrangement distance Q(u) of the light guide bar group GR is made longer than the arrangement distance P(u) between the light guide bars 11, and thus it is possible to minimize the inclination angle θ of the light guide bar 11.

When the inclination angle θ is small as described above, in the process of the light travelling from the light receiving end 12R to the top end 12T, the light is prevented from reaching the processing portion 13, and thus the light is unlikely to be emitted from the side surface 12S. Consequently, the light guide unit UT as shown in FIG. 16B is unlikely to loss light (in short, it is unlikely that the light guide unit UT cannot guide the light to the diffusion plate 43).

The following relational formula C can be derived from the relational formula A and the relational formula B.

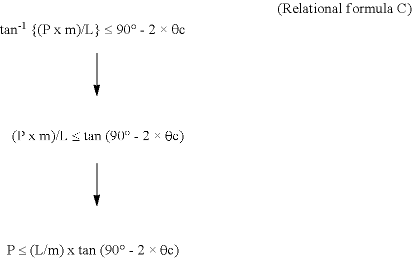

As is understood from what has been described above, the limit value of the inclination (the inclination angle θ) of the light guide bar 11 is determined depending on the critical angle θc°, and furthermore, the arrangement distance P between the light guide bars 11 is determined to achieve such inclination.

### Third Embodiment

A third embodiment will be described. Members that have the same functions as those used in the first and second embodiments are identified with like symbols, and their description will not be repeated.

In the first and second embodiments, the light guide unit UT (see FIG. 12) in which the light guide bar groups GR are symmetrically arranged about a line and the light guide unit UT (see FIG. 14) in which the light guide bar groups GR are symmetrically arranged about a point are described as the example. However, the present invention is not limited to these arrangements.

For example, because of the visual characteristics of a person, the person can hardly sense the decrease in the brightness of the regions other than the center of the liquid crystal display panel 59 (in short, even if the brightness of the peripheral areas of the liquid crystal display panel 59 is somewhat decreased, the liquid crystal display panel 59 is recognized to have an uniform brightness). Then, when the backlight unit 49 emits planar light in which the brightness of the vicinity of the center of the liquid crystal display panel 59 is higher than that of the peripheral areas, the brightness of the liquid crystal display panel 59 is effectively increased (for example, the liquid crystal display device 69 can provide an image of high brightness to the user even if the power consumption is limited).

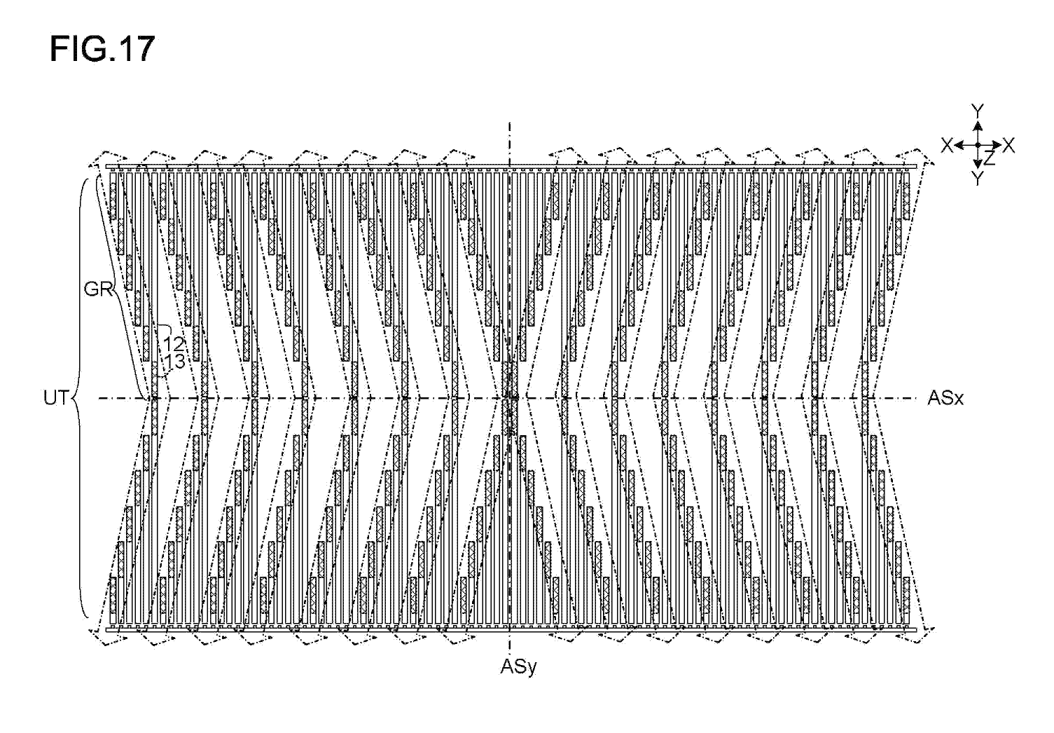

Hence, for example, as shown in the plan view of FIG. 17, the light guide bars 11 (the light guide bar group GR) may be arranged. Specifically, the direction (the Y direction) of the length of the light guide bar 11 is perpendicular to the direction (the X direction) in which the light receiving ends 12R of the light guide bars 11 are aligned, and, as in FIG. 12, the light guide bars 11 are symmetrically arranged about a symmetrical axis ASx along the X direction. The backlight unit 49 shown in FIG. 17 differs from the backlight unit 49 shown in FIG. 12 in that there is also a symmetrical axis ASy along the Y direction, and that the light guide bar group GR is symmetrically arranged about the symmetrical axis ASy.

Specifically, in the X direction that divides two light guide bar groups GR aligned along the Y direction into two parts, the symmetrical axis ASx is present; in the Y direction that divides 16 light guide bar groups GR aligned along the X direction into two parts, the symmetrical axis ASy is present (in short, the light guide bar groups GR (hence, the light guide bars 11) are arranged symmetrically both in a vertical direction and in a lateral direction. In the arrangement of the light guide bar groups GR shown in FIG. 17, the light guide bar groups GR can also be said to be symmetrically arranged about an intersection point between the two symmetrical axes ASx and AXSy that is a symmetrical center.

In the backlight unit 49 configured as described above, as in FIG. 12, in the light guide bar groups GR opposite each other along the Y direction, the path obtained by connecting the light from the processing portions 13 (hence, the light emission portions 12N) arranged in the side of the top ends 12T of the light guide bars 11 is formed in the shape of a broken line (V-shaped) indicated by the arrows of alternate long and short dashed lines. The path of the light in the backlight unit 49 shown in FIG. 17 differs from the path of the light in the backlight unit 49 shown in FIG. 12 in that the bottom (bending point) of the V-shaped broke line faces the symmetrical axis ASy along the Y direction (in the light guide bar group GR, the light guide bar 11 having the longest length is the closest to the symmetrical axis ASy along the Y direction as compared with the other shorter light guide bars 11).

In other words, the bottom of the V-shaped path of the light is close to the symmetrical axis ASy along the Y direction overlapping the vicinity of the center of the planar light. Consequently, the brightness of the vicinity of the center of the planar light is higher than that of the peripheral areas. Hence, in the backlight unit 49 shown in FIG. 17, the brightness of the liquid crystal display panel 59 is effectively enhanced.

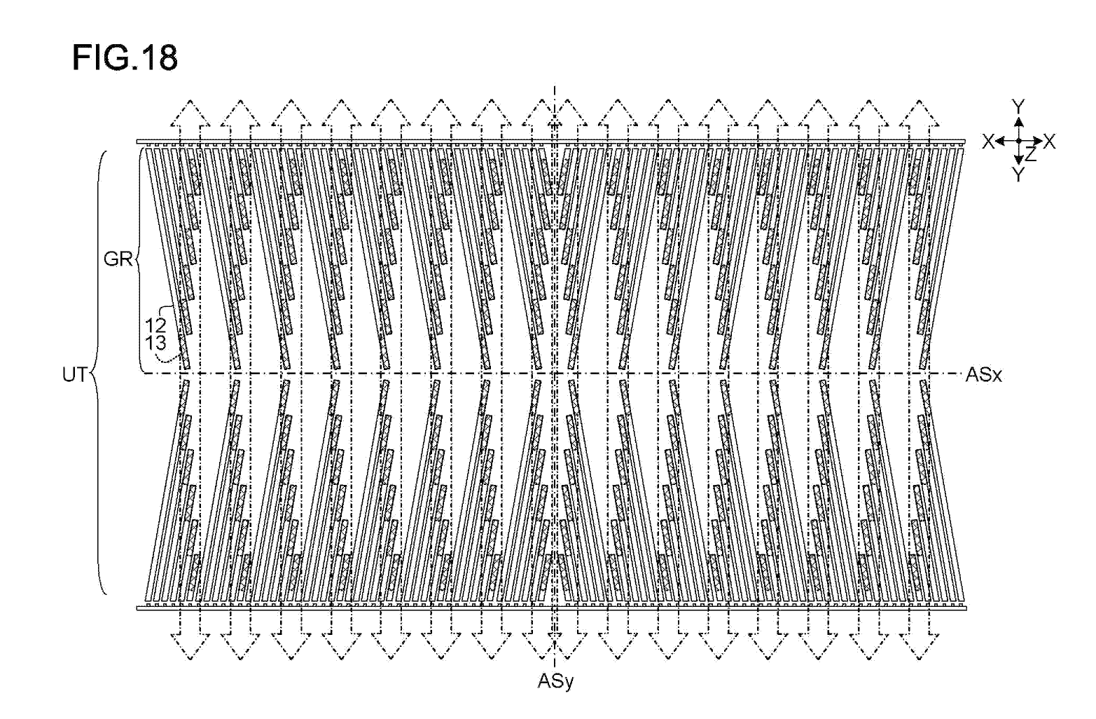

Moreover, for example, as shown in the plan view of FIG. 18, the light guide bars 11 (the light guide bar group GR) may be arranged. Specifically, the light guide bar groups GR (hence, the light guide bars 11) shown in the perspective view of FIG. 13 are arranged, as in FIG. 17, symmetrically both in a vertical direction and in a lateral direction. Specifically, in the X direction that divides two light guide bar groups aligned along the Y direction into two parts, the symmetrical axis ASx is present; in the Y direction that divides 16 light guide bar groups GR aligned along the X direction into two parts, the symmetrical axis ASy is present. The light guide bar groups GR are symmetrically arranged about both the symmetrical axes ASx and ASy. (In the arrangement of the light guide bar groups GR shown in FIG. 18, the light guide bar groups GR can also be said to be symmetrically arranged about the intersection point between the two symmetrical axes ASx and AXSy.)

In the backlight unit 49 configured as described above, as in FIG. 14, in the light guide bar groups GR opposite each other along the Y direction, the path obtained by connecting the light from the processing portions 13 arranged in the side of the top ends 12T of the light guide bars 11 is formed in the shape of a straight line indicated by the arrows of alternate long and short dashed lines. The path of the light in the backlight unit 49 shown in FIG. 18 differs from the path of the light in the backlight unit 49 shown in FIG. 14 in that the light guide bars 11 are not spaced regularly, and are arranged close to the symmetrical axis ASy along the Y direction.

In other words, the straight path of the light is arranged close to the symmetrical axis ASy along the Y direction overlapping the vicinity of the center of the planar light. Consequently, the brightness of the vicinity of the center of the planar light is higher than that of the peripheral areas. Hence, in the backlight unit 49 shown in FIG. 18, the brightness of the liquid crystal display panel 59 is effectively enhanced.

When, as described above, the arrangement of the light guide bars 11 is either a line-symmetrical arrangement or a point-symmetrical arrangement, the characteristic of the brightness distribution of the planar light is also either a line-symmetrical distribution or a point-symmetrical distribution. Hence, the backlight unit 49 including the light guide bars 11 described above is suitable for local dimming control.

### Fourth Embodiment

A fourth embodiment will be described. Members that have the same functions as those used in the first to third embodiments are identified with like symbols, and their description will not be repeated.

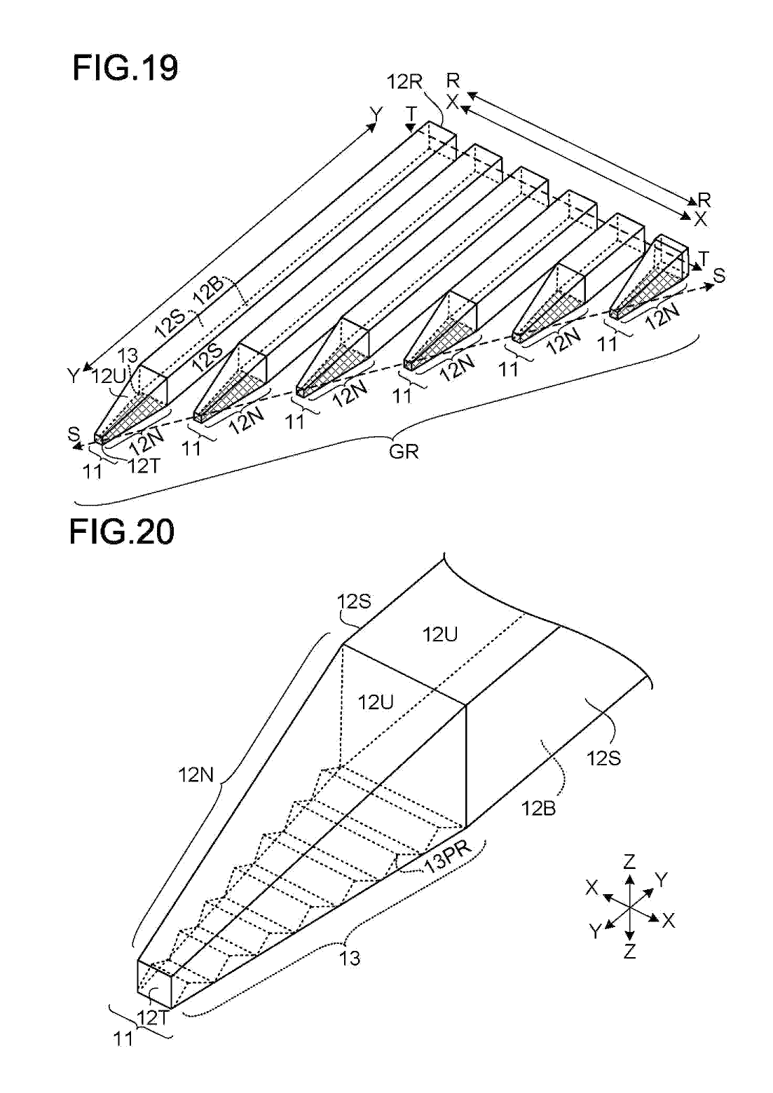

The light guide bar 11 that has been described in the first to third embodiments is a rectangular parallelepiped. However, the shape of the light guide bar 11 is not limited to this shape. For example, as shown in FIG. 19 and FIG. 20 (which is an enlarged view of FIG. 19), the light guide bar 11 is tapered. For example, the top surface 12U and the side surfaces 12S included in the light emission portion 12N of the light guide bar 11 are inclined, and thus the light emission portion 12N is tapered (the cross-sectional area (the cross-sectional area in the XZ plane direction) of the light emission portion 12N is decreased as the top end 12T extends farther).

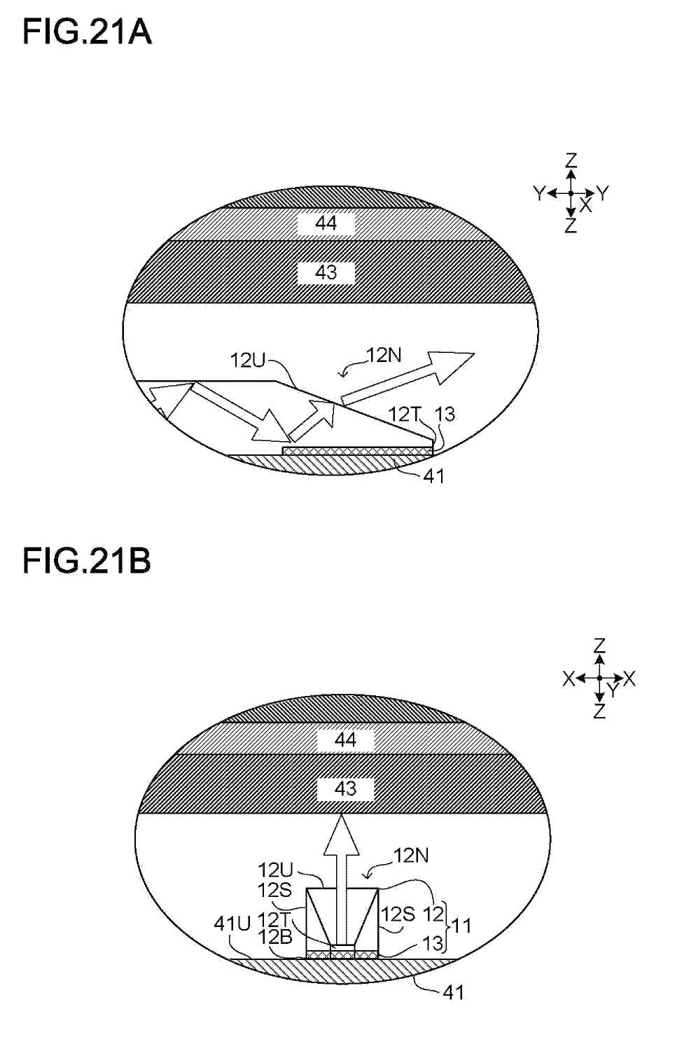

In the light guide bar 11 described above, as shown in FIGS. 21A and 21B, which are cross-sectional views of the light guide bar 11 (the directions in which the cross sections of FIGS. 21A and 21B are taken are the same as those of FIGS. 2A and 2B, respectively; white arrows mean the light), the possibility that, in the light emission portion 12N, the light reaches the processing portion 13 and exits to the outside is increased (when the light receiving side of the processing portion 13 faces the diffusion plate 43, the bottom surface 12B that is one surface of the side surfaces 12S where the processing portion 13 is formed is the farthest away from the diffusion plate 43 as compared with the other side surfaces 12S).

Hence, the light is not emitted from the top end 12T of the light guide bar 11, and easily passes through the top surface 12U and reaches the diffusion plate 43 (in other words, light that is unlikely to enter the diffusion plate 43 is not emitted from the light guide bar 11). Consequently, in the backlight unit 49, a bright spot produced by the light emitted from the top end 12T is reduced, and it is possible to obtain planar light (illumination light) having satisfactory evenness.

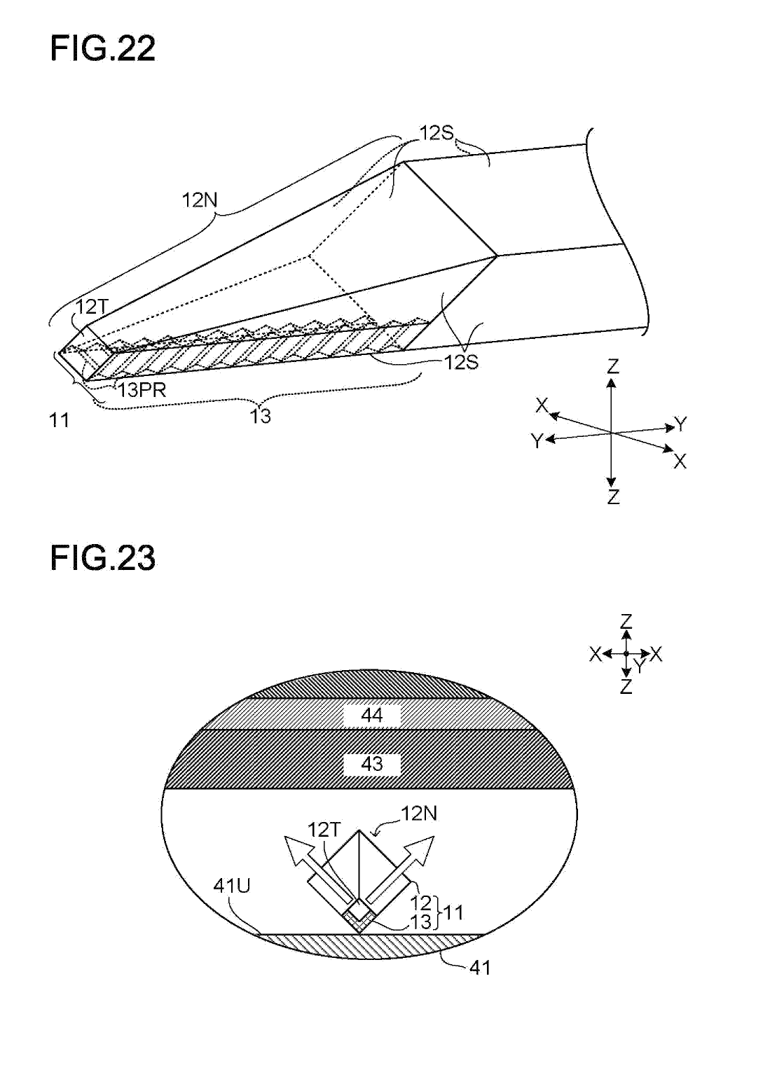

There is a light guide bar 11, other than the light guide bar 11 shown in FIG. 20, that is tapered as shown in FIG. 22 and FIG. 23 (which is a cross-sectional view of FIG. 22). Specifically, in this light guide bar 11, among the four side surfaces 12S, two side surfaces adjacent to each other are inclined, and thus the light emission portion 12N is tapered. Preferably, as shown in FIG. 23, two side surface 12S where the processing portions 13 are formed are separate from the reflective surface 41U of the reflective sheet 41, and the connection of the two side surfaces 12S is arranged to face the reflective surface 41U (as shown in FIG. 22, the processing portions 13 have about the same length as the width of the top end 12T of the light guide bar 11, and are formed along the direction in which the side surfaces 12S extend).

In the case where, as described above, the light receiving side of the processing portions 13 faces the diffusion plate 43, when the two side surfaces 12S where the processing portions 13 are formed are the farthest away from the diffusion plate 43 as compared with the other side surfaces 12S, in the optical path of the light (see whit arrows) of FIG. 23, as compared with that of FIG. 6, the optical path extending from the processing portions 13 to the diffusion plate 43 is made longer. Consequently, the planar light shone on the diffusion plate 43 becomes light that is obtained by overlapping the light from a plurality of light guide bars 11 in a wide range and that has no variations in the amount of light, and the quality of the backlight is enhanced (in the liquid crystal display device 69 shown in FIGS. 21B and 23, the distance from the diffusion plate 43 to the processing portions 13 of the light guide bar 11 is longer than the distance from the reflective sheet 41 to the processing portions 13).

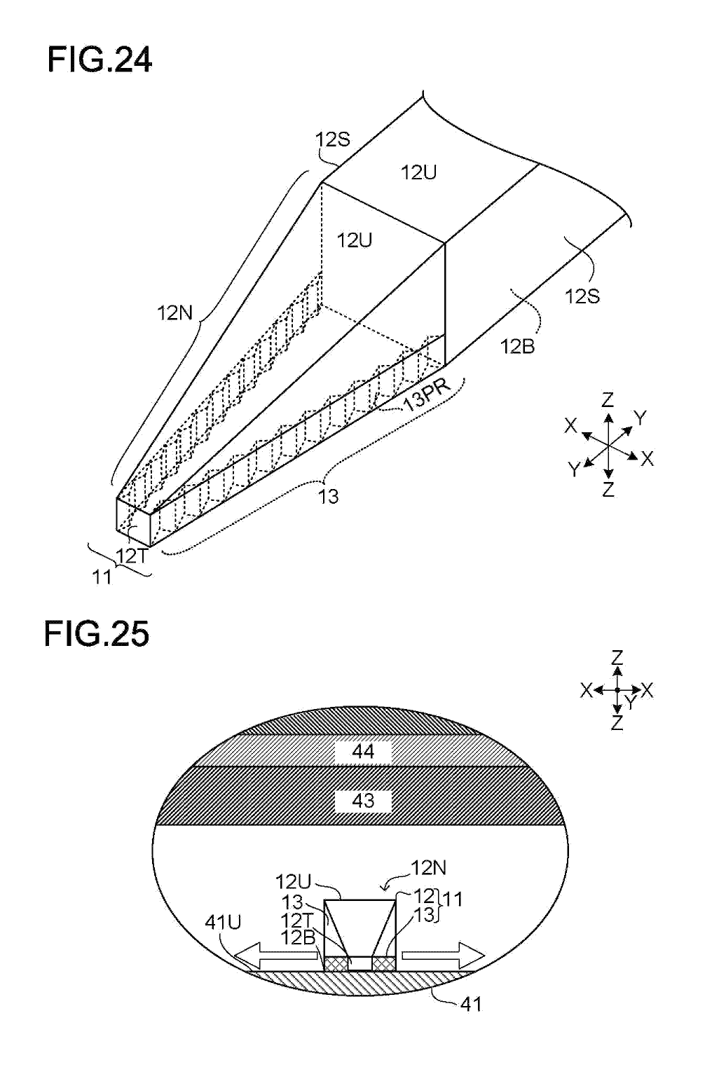

For example, as shown in FIG. 24 and FIG. 25 (which is a cross-sectional view of FIG. 24), in at least part of the side surfaces 12S opposite each other, the processing portion 13 may be formed. Specifically, the processing portion 13 is formed such that its height is substantially equal to the height (the width of the top end 12T of the light guide bar 11) of the top end 12T of the light guide bar 11, and is formed along the direction which the side surface 12S of the light emission portion 12N extends.

Since, in the light guide bar 11 described above, as compared with the light guide bar 11 shown in FIG. 7, the processing portions 13 formed in the side surfaces 12S are the farthest away from the diffusion plate 43, in the optical path of the light (see whit arrows) of FIG. 25, as compared with that of FIG. 7, the optical path extending from the processing portions 13 to the diffusion plate 43 is made longer. Consequently, the light becomes light that is obtained by further overlapping the light from a plurality of light guide bars 11 in a wide range and that has no variations in the amount of light, and the quality of the backlight is enhanced.

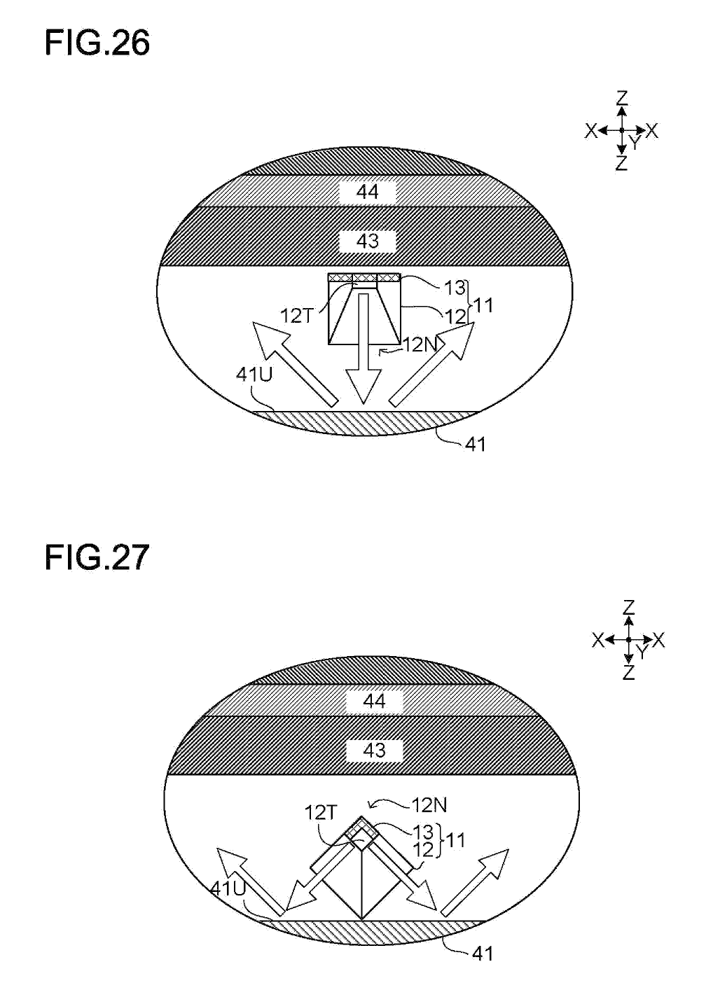

In the light guide bar 11 shown in FIG. 21B, as shown in FIG. 26, the processing portion 13 is planar, and the light receiving side (the light receiving surface) of the surface may face the reflective sheet 41 (specifically, the reflective surface 41U) (in particular, the distance from the reflective sheet 41 to the processing portion 13 is longer than the distance from the diffusion plate 43 to the processing portion 13). In the case where, as described above, the light receiving side of the processing portion 13 faces the reflective sheet 41, when the one surface of the side surfaces 12S where the processing portion 13 is formed is the farthest away from the reflective sheet 41 as compared with the other side surfaces 12S, the light (see white arrows) of FIG. 26 travels, as in FIG. 8, from the processing portion 13 toward the reflective sheet 41, is reflected off the reflective sheet 41 and then reaches the diffusion plate 43. Hence, the optical path extending from the processing portion 13 to the diffusion plate 43 is reliably made longer, and consequently, the light becomes light that is obtained by overlapping the light from a plurality of light guide bars 11 in a wide range and that has no variations in the amount of light, and the quality of the backlight is enhanced.

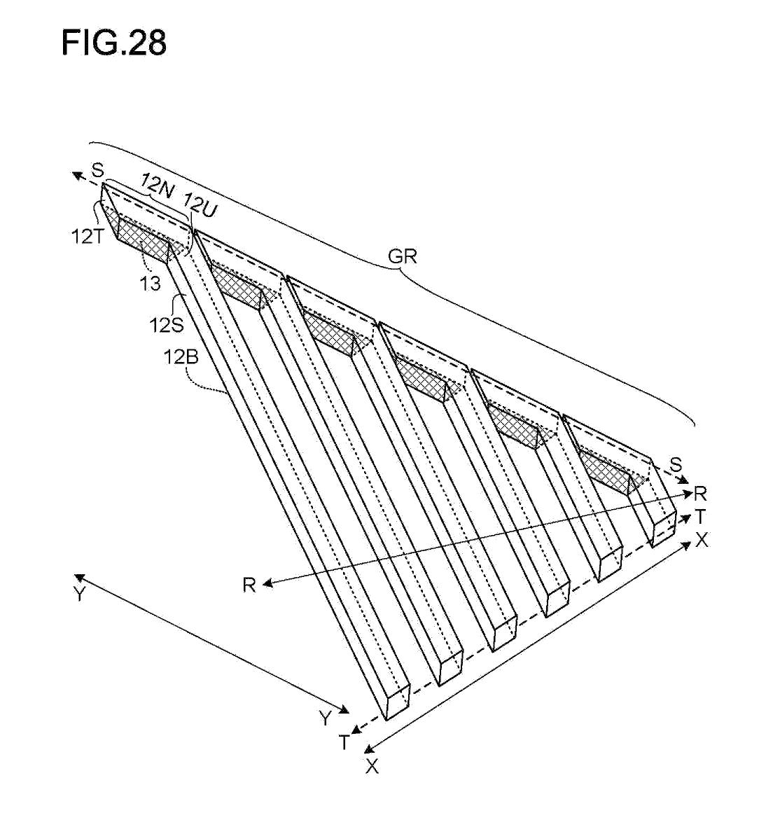

Preferably, in the light guide bar 11 shown in FIG. 27, as shown in FIG. 9, the surfaces (light receiving surfaces) of the processing portions 13 face the reflective sheet 41, and the two side surfaces 12S where the processing portions 13 are formed are separate from the diffusion plate 43 of the reflective sheet 41, and the connection of the two side surfaces 12S is arranged to face (close to) the diffusion plate 43 (when the light receiving side of the processing portions 13 faces the reflective sheet 41, the two surfaces of the side surfaces 12S where the processing portions 13 are formed are the farthest away from the reflective sheet 41 as compared with the other side surfaces 12S). This because, even in this configuration, the optical path extending from the processing portions 13 to the diffusion plate 43 is reliably made longer (the distance from the reflective sheet 41 to the processing portion 13 of the light guide bar 11 is longer than the distance from the diffusion plate 43 to the processing portion 13).

### Fifth Embodiment

A fifth embodiment will be described. Members that have the same functions as those used in the first to fourth embodiments are identified with like symbols, and their description will not be repeated.

In the fourth embodiment, the light guide bar 11 including the straight and tapered light emission portion 12N has been described. However, the shape of the tapered light guide bar 11 is not limited to the straight shape. For example, as shown in FIG. 28, the light guide bar 11 may be bent.

Specifically, the light guide bar 11 is bent, and the processing portion 13 is included in a portion extending from the bent place to the top end 12T. The direction in which the light emission portion 12N including the processing portion 13 extends (in short, the direction from the bent place to the top end 12T) intersects, in the light guide bar group GR, the R direction in which the light guide bars 11 are aligned and is also perpendicular to the light receiving end arrangement line T formed by connecting the positions of the light receiving ends 12R.

Moreover, in the light guide bar group GR, a plurality of linear light emission portions 12N are arranged such that they are perpendicular to the light receiving end arrangement line T and are continuous. Hence, the light emission portion arrangement line S formed by connecting the light emission portions 12N is also perpendicular to the light receiving end arrangement line T.

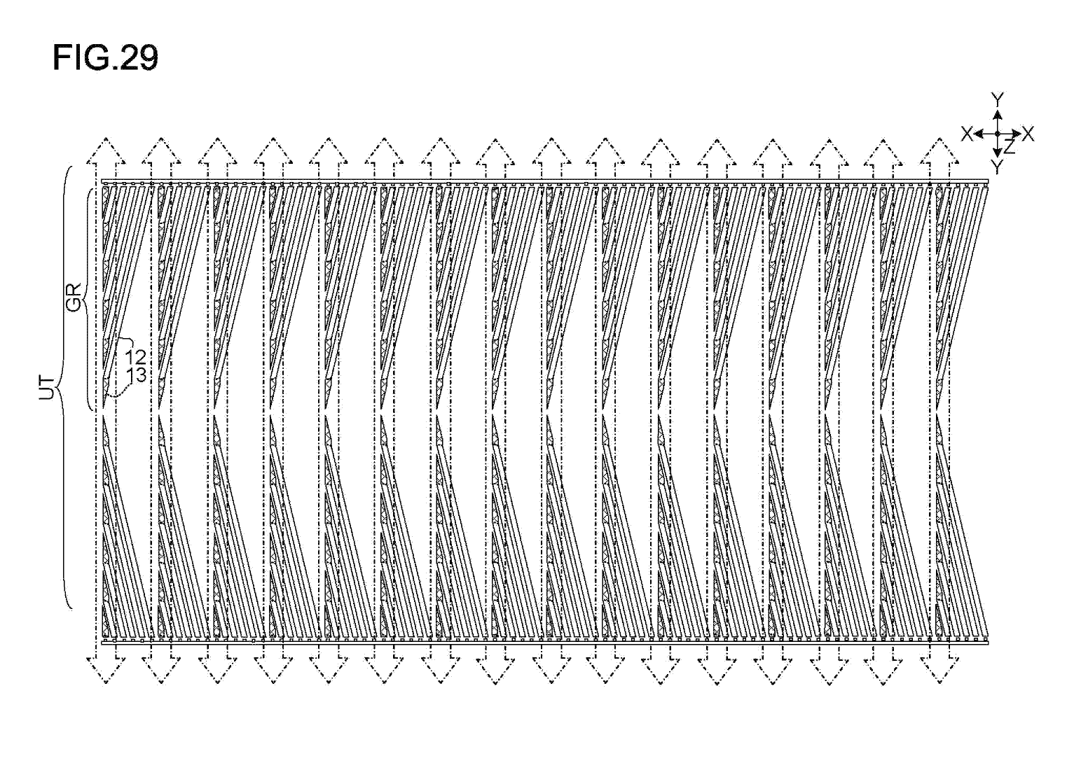

In the light guide bar group GR described above, the light emission portion arrangement line S coincides with the direction in which the light emission portions 12N extend. Hence, as shown in FIG. 29, which is a plan view obtained by aligning a plurality of light guide bar groups GR shown in FIG. 28, a path obtained by connecting light from the light emission portions 12N reliably becomes straight, as indicated by the arrows of alternate long and short dashed lines.

Since, in the backlight unit 49 including the light guide unit UT shown in FIG. 29, as shown in FIG. 14, the light (see the arrows of alternate long and short dashed lines) of the backlight unit 49 is not displaced, the backlight is unlikely to have variations in the amount of light.

### Sixth Embodiment

A sixth embodiment will be described. Members that have the same functions as those used in the first to fifth embodiments are identified with like symbols, and their description will not be repeated.

In the light guide unit UT of the first to fourth embodiments, the area of the processing portion 13 of each of the light guide bars 11 is constant. However, the present invention is not limited to this configuration.

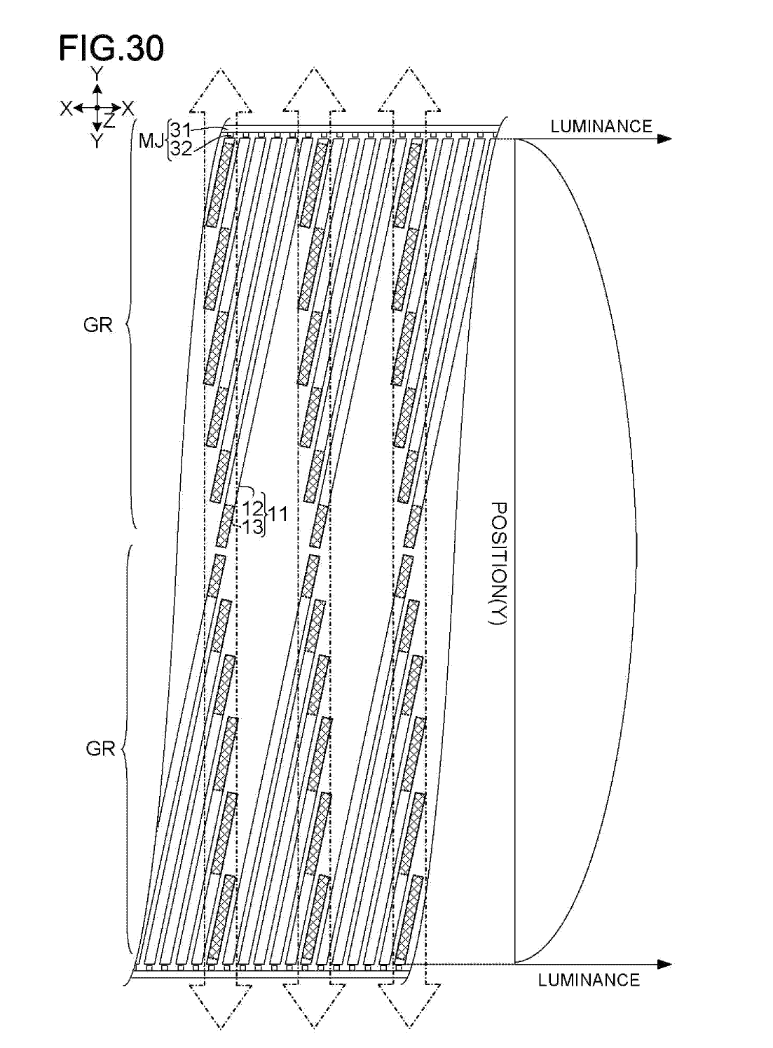

For example, as shown in the plan view of FIG. 30, in the light guide unit UT, as the length of the light guide bar 11 becomes longer, the area of the processing portion 13 may become smaller. In this configuration, when a plurality of LEDs 32 are equal in the brightness of light emission, the brightness of the light from the light guide bar 11 (specifically, the brightness per unit area of the processing portion 13) is inversely proportional to the area of the processing portion 13. Specifically, as the light guide bar 11 having a longer length, the area of the processing portion 13 is reduced, and the brightness of the light from the side of the end of the light guide bar 11 is increased.

Hence, as shown in a brightness distribution diagram (the brightness distribution diagram showing the relationship between the positions in the Y direction and the brightness) illustrated next to the plan view of FIG. 30, the vicinity of the center between the mounting substrates 31, that is, the vicinity of the center of the liquid crystal display panel 59 (in short, the vicinity of the center of the liquid crystal display panel 59 when the light receiving end arrangement line T is overlapped with the longitudinal side of the rectangular liquid crystal display panel 59) is brighter than the vicinity of the ends along the longitudinal direction of the liquid crystal display panel 59.

In this configuration, because of visual characteristics, for example, the user is unlikely to notice the darkness in the vicinity of the ends along the longitudinal direction of the liquid crystal display panel 59. Hence, when the light guide unit UT described above is incorporated in the liquid crystal display device 69, it is possible to provide a satisfactory image to the user while reducing the power consumption of the LEDs 32.

Since the backlight unit 49 incorporating the light guide unit UT can perform local dimming, it is possible to partially control the amount of light according to an image displayed on the liquid crystal display panel 59. Hence, needless to say, the power consumption is effectively reduced. Since the backlight unit 49 controls the backlight in synchronization with the image displayed on the liquid crystal display panel 59, it is also possible to enhance the moving image display performance of the liquid crystal display device 69.

FIG. 12 is the enlarged view of the light guide unit UT having a point-symmetrical arrangement. However, the light guide unit UT in which the areas of the processing portions 13 are different is not limited to the light guide unit UT having a point-symmetrical arrangement; it is needless to say that it can be realized by the light guide unit UT shown in FIG. 12 and having a line-symmetrical arrangement.

### Seventh Embodiment

A seventh embodiment will be described. Members that have the same functions as those used in the first to sixth embodiments are identified with like symbols, and their description will not be repeated.

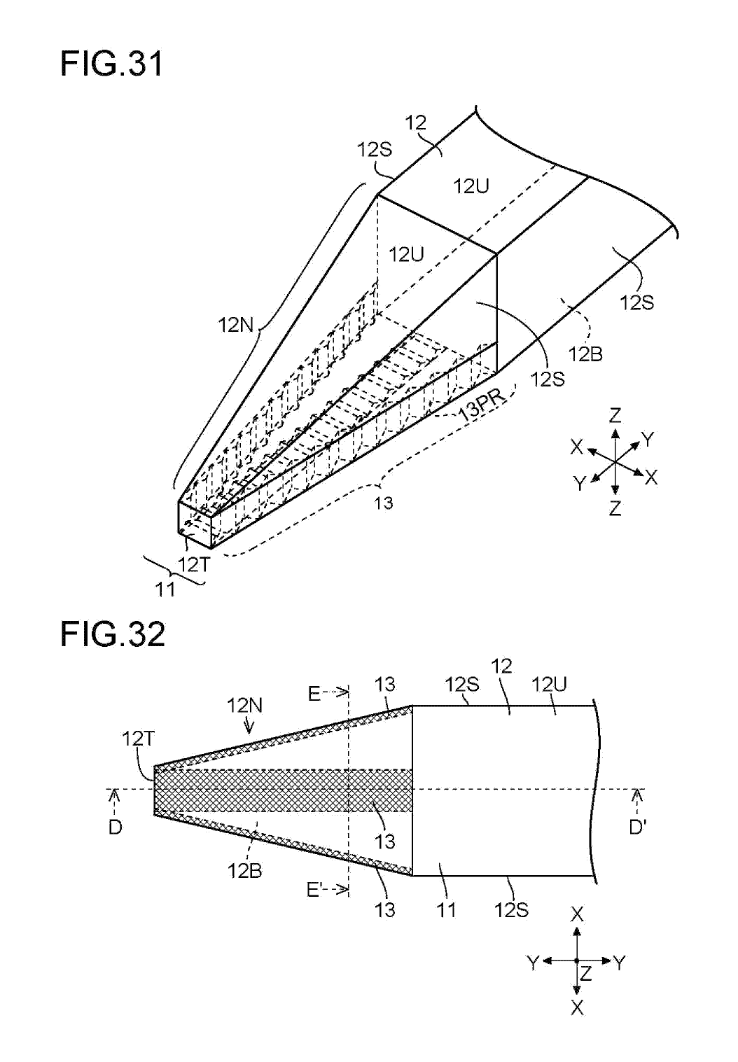

In the seventh embodiment, as shown in FIGS. 31 and 32, in a variation of the fourth embodiment (see FIG. 24) described above, the processing portion 13 is also formed in the bottom surface 12B (which is one of the side surfaces 12S of the light guide bar 11 and which is the opposite surface of the top surface 12U) of the light guide bar 11.

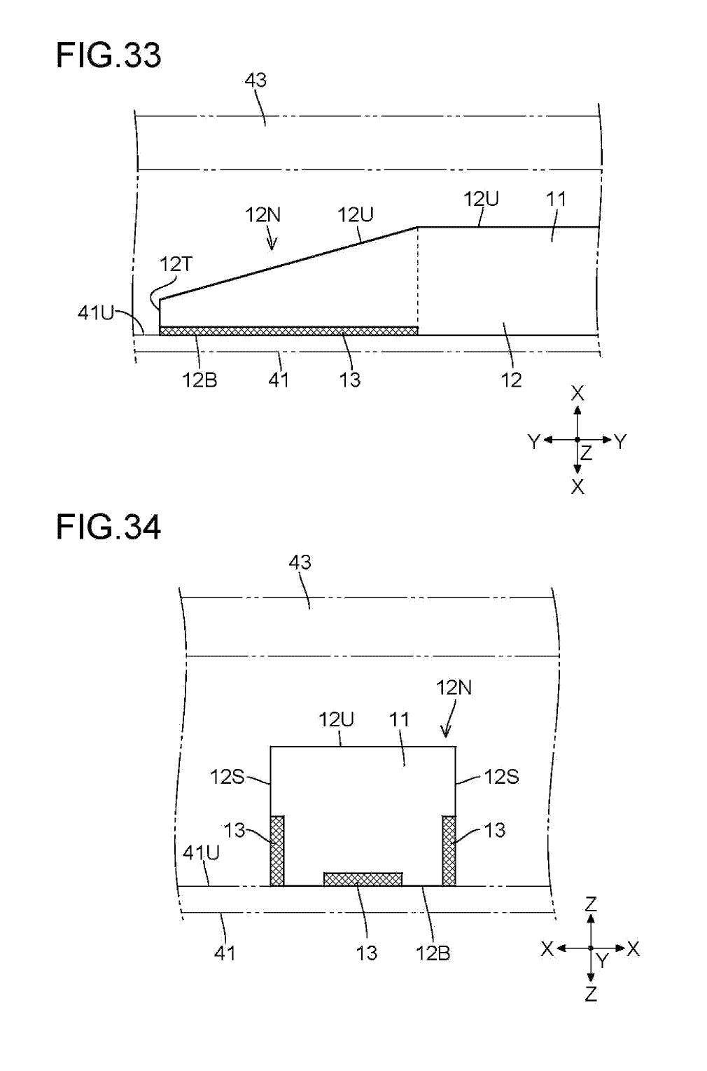

Specifically, in the seventh embodiment, for example, in the light guide bar 11, the top surface 12U and the side surfaces 12S included in the light emission portion 12N are inclined, and thus the light emission portion 12N is tapered. The light guide bar 11 configured as described above is arranged such that, as shown in FIG. 33, the bottom surface 12B included in the light emission portion 12N is parallel to the reflective sheet 41 (the reflective surface 41U) and that, as shown in FIG. 34, the side surfaces 12S included in the light emission portion 12N are perpendicular to the reflective sheet 41 (the reflective surface 41U). Hence, the bottom surface 12B of the light guide bar 11 is arranged opposite the reflective surface 41U of the reflective sheet 41; the side surfaces 12S are arranged perpendicular to the reflective surface 41U of the reflective sheet 41. In part of each of the side surfaces 12S opposite each other in the light guide bar 11, the processing portion 13 is formed; in part of the bottom surface 12B in the light guide bar 11, the processing portion 13 is also formed. In other words, in the seventh embodiment, the processing portions 13 are provided in the side surfaces 12S (the surfaces perpendicular to the reflective sheet 41) in the light guide bar 11, and the processing portion 13 is also provided in the bottom surface 12B (the surface opposite the reflective sheet 41) in the light guide bar 11. The height of the processing portion 13 of the side surface 12S is substantially equal to, for example, the height (the width of the top end 41T of the light guide bar 11) of the top end 41T of the light guide bar 11, and the processing portion 13 is formed along the direction which the side surface 12S of the light emission portion 12N extends. For example, in the vicinity of the center in the width direction (the X direction), the width of the processing portion 13 of the bottom surface 12B is substantially equal to the width (the width in the X direction) of the top end 41T of the light guide bar 11, and the processing portion 13 is formed so as to extend along the length direction (the Y direction) of the light guide bar 11.

As shown in FIGS. 33 and 34, the processing portion 13 formed in the bottom surfaces 12B is configured such that its light receiving side (the light receiving surface) faces the diffusion plate 43.

The other configurations in the seventh embodiment are the same as in the fourth embodiment described above.

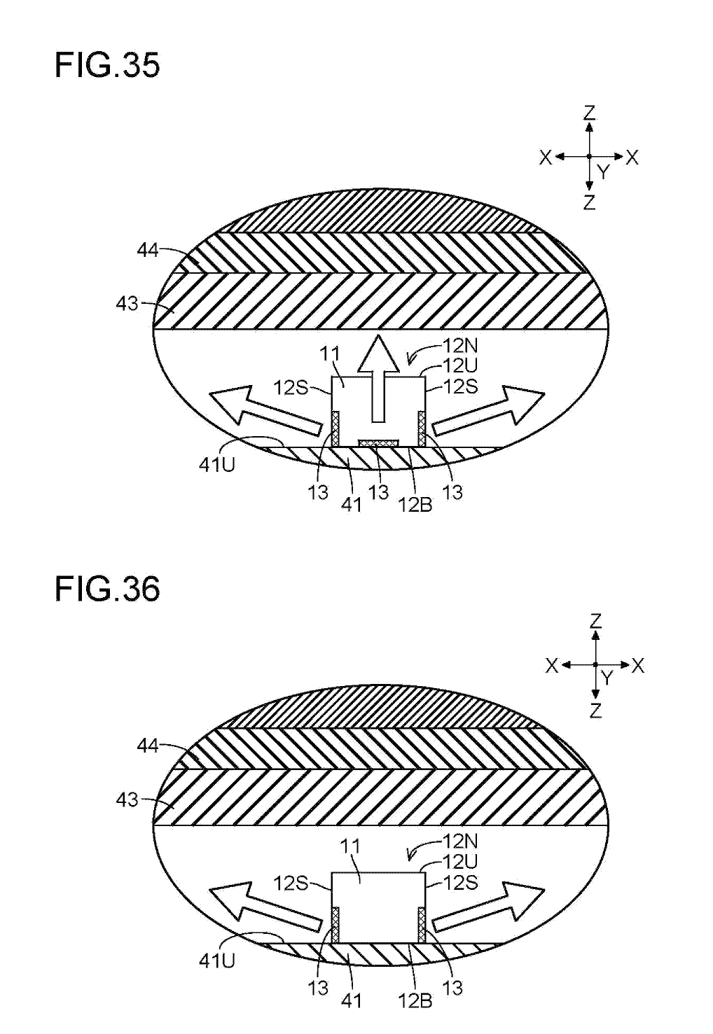

In the seventh embodiment configured as described above, as shown in FIG. 35, the light becomes light that is obtained by overlapping the light from the side surfaces 12S of a plurality of light guide bars 11 in a wide range and that has no variations in the amount of light. In the seventh embodiment, as described above, the processing portion 13 is formed in the bottom surface 12B of the light guide bar 11, and thus the light (see white arrows) is also applied to a portion of the diffusion plate 43 directly above the light guide bar 11 that the light emitted from the side surfaces 12S has difficulty in reaching. In this way, the quality of the backlight is further enhanced.

When the processing portion 13 is not formed in the bottom surface 12B of the light guide bar 11, as shown in FIG. 36, the light is unlikely to reach the portion of the diffusion plate 43 directly above the light guide bar 11, and thus a dark portion may be produced. In particular, when the distance between the reflective sheet 41 and the diffusion plate 43 is decreased in order to reduce the thickness of the backlight, the optical path of the light is reduced, and thus the dark portion is more likely to be produced. In this case, as described in the seventh embodiment, it is preferable to form the processing portion 13 in the bottom surface 12B of the light guide bar 11 because this effectively reduces the occurrence of the dark portion.

As described above, in the seventh embodiment, in addition to the side surfaces 12S of the light guide bar 11, the processing portion 13 is also formed in the bottom surface 12B, and thus it is possible to overlap the light from the light guide bars 11 in a wide range, and to effectively reduce the occurrence of the dark portion in the area directly above the light guide bar 11. Thus, it is possible to effectively reduce variations in the amount of light. Moreover, since, even when the distance between the diffusion plate 43 and the reflective sheet 41 is reduced, it is possible to reduce the occurrence of the dark portion, it is possible to easily reduce the thickness of the backlight.

Although, in the seventh embodiment discussed above, the description has been given of the example where the processing portion 13 is formed in part of the bottom surface 12B of the light guide bar 11, the processing portion 13 may be formed in the entire bottom surface 12B (the bottom surface 12B included in the light emission portion 12N) of the light guide bar 11. The shape of the processing portion 13 of the bottom surface 12B may be changed into a shape different from that described above. In the processing portions 13 of the side surfaces 12S, the formation region, the shape and the like thereof can be changed as necessary.

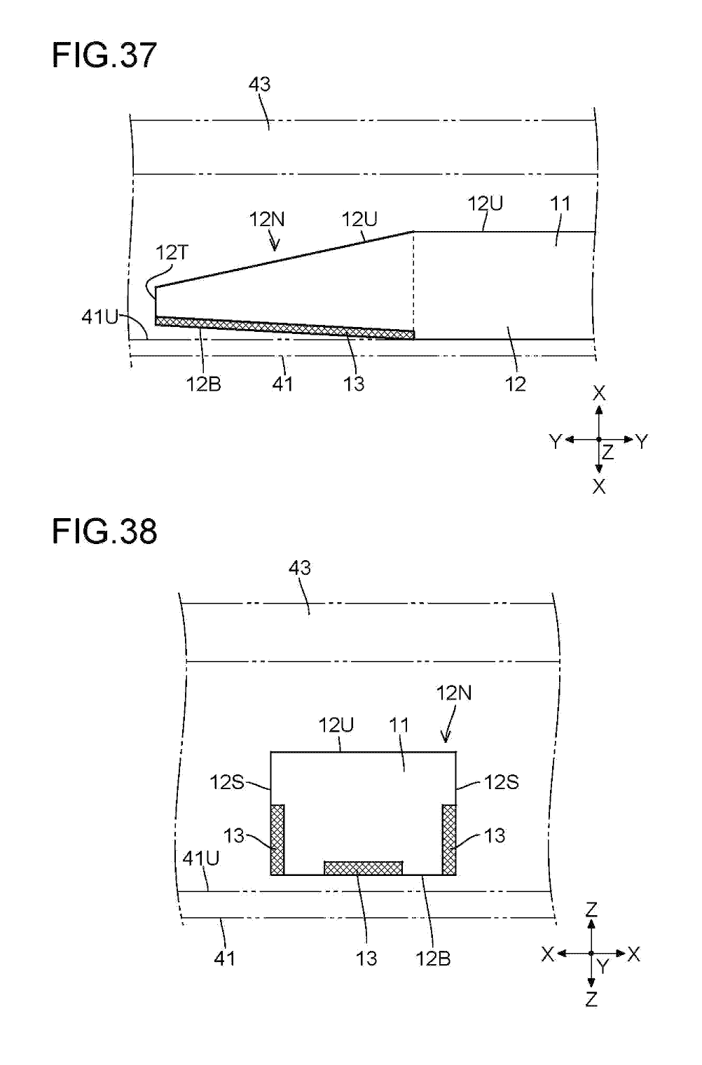

Although, in the seventh embodiment discussed above, the description has been given of the example where the top surface 12U and the side surfaces 12S included in the light emission portion 12N are tapered, as shown in FIGS. 37 and 38, for example, the bottom surface 12B included in the light emission portion 12N can be tapered. Specifically, the bottom surface 12B included in the light emission portion 12N may not be parallel to the reflective sheet 41, and may be inclined at a predetermined angle.

As shown in FIGS. 34 and 38, the processing portion 13 of the bottom surface 12B is preferably formed parallel to the reflective sheet 41 (or the diffusion plate 43) as seen in a cross section in the length direction (the Y direction). Hence, the bottom surface 12B included in the light emission portion 12N may be, as described above, parallel to the reflective sheet 41 or inclined with respect to the reflective sheet 41.

Although, in the seventh embodiment discussed above, the description has been given of the example where the processing portion 13 is configured as the prism processing portion 13 where the triangular prisms 13PR are arranged close to each other, the processing portion 13 may be configured as a prism processing portion where, for example, pyramid prisms other than the triangular prisms are arranged close to each other.

Although, in the seventh embodiment discussed above, the description has been given of the example where the top end portion of the light guide bar 11 is tapered, the top end portion of the light guide bar 11 may not be tapered as described in the first to third embodiments.

### Other Embodiments

The present invention is not limited to the embodiments described above; many modifications are possible without departing from the spirit of the present invention.

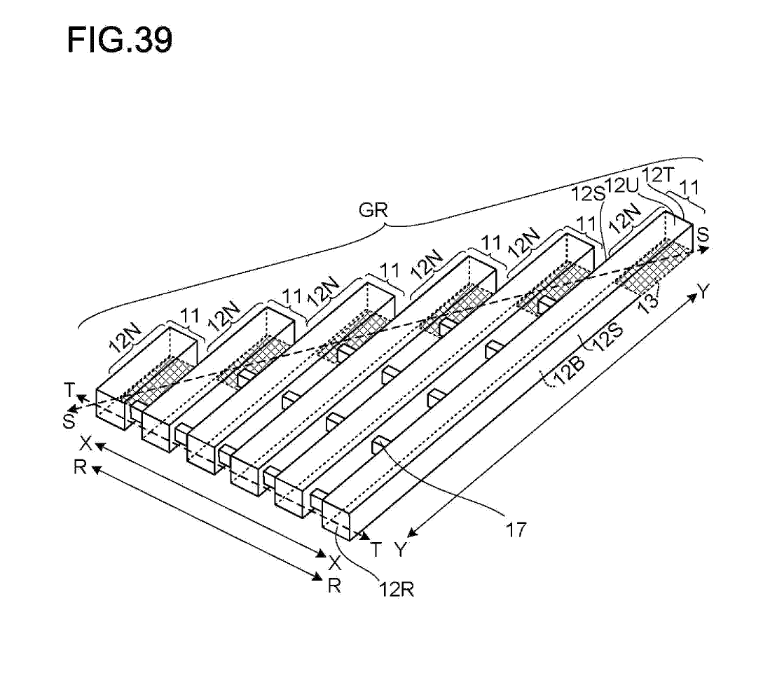

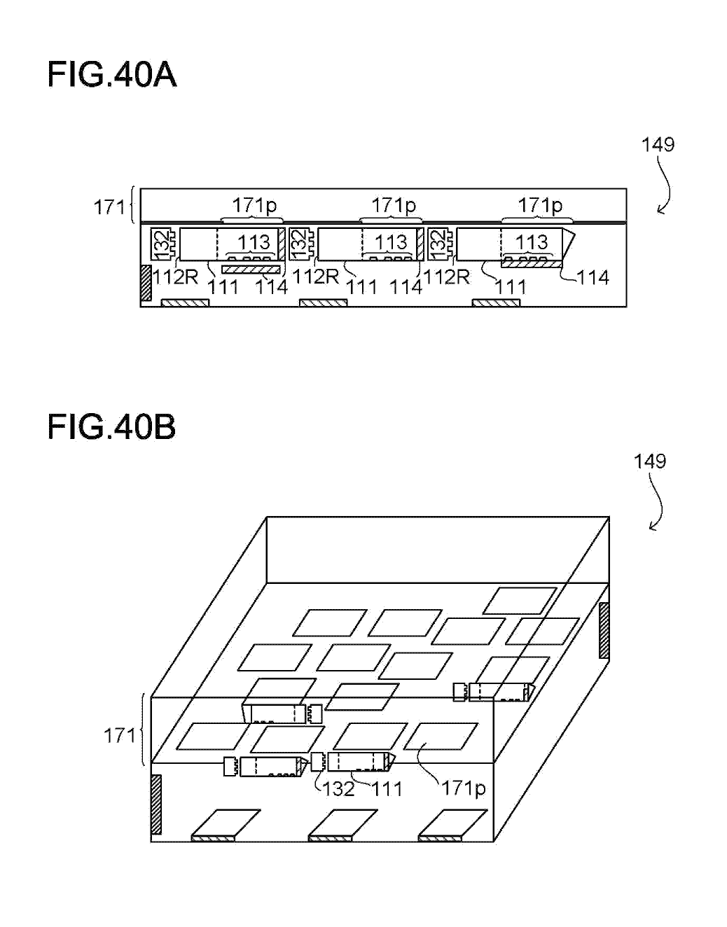

For example, as shown in FIG. 39, between the side surfaces 12S of the light guide bars 11, coupling members 17 are placed, the light guide bars 11 are connected and thus the light guide bar group GR may be formed. In this configuration, it is possible to eliminate the inconvenience in which, when the backlight unit 49 is manufactured, the light guide bars 11 are individually aligned to form the light guide bar group GR and hence the light guide unit UT. In other words, only by aligning the light guide bar groups GR, the light guide unit UT is completed.

The manufacturing of the light guide bar group GR including the coupling members 17 is not particularly limited. For example, a mold in which cuts of the shapes of the coupling members 17 are formed is used, and thus integral molding (such as injection molding) may be performed; alternatively, separate light guide bars 11 may be coupled using the coupling members 17 and an adhesive or the like to form the light guide bar group GR.

The type of LED 32 is not particularly limited. For example, as an example of the LED 32, there is an LED that includes a blue light emitting LED chip (a light emitting chip) and a fluorescent member which receives light from the LED chip to emit yellow light (the number of LED chips is not particularly limited). This type of LED 32 generates white light using the light from the blue light emitting LED chip and the light of the fluorescent emission.

However, the fluorescent member incorporated in the LED 32 is not limited to the yellow light emitting fluorescent member. For example, the LED 32 may include a blue light emitting LED chip and a fluorescent member which receives light from the LED chip to emit green light and red light; this LED 32 may generate white light using the blue light from the LED chip and the light (green light/red light) of the fluorescent emission.

The LED chip incorporated in the LED 32 is not limited to the blue light emitting LED chip. For example, the LED 32 may include a red light emitting red LED chip, a blue light emitting blue LED chip and a fluorescent member which receives light from the blue LED chip to emit green light. This is because this type of LED 32 can generate white light using the red light from the red LED chip, the blue light from the blue LED chip and the green light of the fluorescent emission.

The LED 32 containing no fluorescent member may be used. For example, the LED 32 may include a red light emitting red LED chip, a green light emitting green LED chip and a blue light emitting blue LED chip, and may generate white light using the light from all the LED chips.

The light emitted from the individual light guide bars 11 is not limited to white light; red light, green light and blue light may be emitted. The light guide bars 11 that emit red light, green light and blue light are arranged as close to each other as possible to generate white light by the mixing of the light (for example, the light guide bar 11 emitting red light, the light guide bar 11 emitting green light and the light guide bar 11 emitting blue light are arranged adjacent to each other).

Needless to say, embodiments obtained by combining the technologies disclosed above as necessary are also included in the technical scope of the present invention.

### LIST OF REFERENCE SYMBOLS

11 light guide bar (light guide member)
12 light propagation portion of the light guide bar
12R light receiving end of the light guide bar
12T top end of the light guide bar
12S side surface of the light guide bar
12B bottom surface which is one side surface of the light guide bar
12U top surface which is one side surface of the light guide bar
T light receiving end arrangement line
12N light emission portion
13 processing portion (optical path change processing portion)
13PR triangular prism
S processing portion arrangement line (light emission portion arrangement line)
15 lens
17 coupling member
31 mounting substrate
31U mounting surface
32 LED (light source, light emitting element)
MJ LED module
X direction in which the mounting substrate extends
Y direction in which the mounting substrate alignes
Z direction intersecting the X direction and the Y direction
R direction in which light guide bars are aligned
41 reflective sheet
41U reflective surface
42 backlight chassis
43 diffusion plate
44 prism sheet
45 lens sheet
49 backlight unit (illumination device)
59 liquid crystal display panel (display panel)
69 liquid crystal display device (display device)

1. A light guide unit that includes one or a plurality of light guide member groups where a plurality of light guide members which include a light receiving end for receiving light and which guide the received light are aligned,
wherein each of the light guide members includes:
a light propagation portion that propagates the received light by reflecting the received light multiple times within the light propagation portion; and
a light emission portion that emits the propagated light to an outside and
in the light guide member group, a light receiving end arrangement line formed by connecting positions of the light receiving ends intersects a light emission portion arrangement line formed by connecting positions of the light emission portions.

2. The light guide unit of claim 1,
wherein the light emission portion includes an optical path change processing portion that is either a portion in which a fine shape for converting internal light into an optical path suitable for external emission is processed or a portion which is subjected to dot-type printing processing.

3. The light guide unit of claim 2,
wherein the light guide member is bar-shaped,
the light emission portion is arranged in a side of a bar-shaped top end opposite to a side of the light receiving end of the light and
in the light guide member group, the light guide members have a plurality of different lengths.

4. The light guide unit of claim 2,
wherein the light emission portion is tapered.

5. The light guide unit of claim 2,
wherein the optical path change processing portion is planar, and
a planar direction thereof is parallel to an arrangement plane direction in which a plurality of the light guide members are aligned.

6. The light guide unit of claim 2,
wherein the optical path change processing portion is planar, and
a planar direction thereof intersects an arrangement plane direction in which a plurality of the light guide members are aligned.

7. The light guide unit of claim 5,
wherein, when the light guide member is bar-shaped, the optical path change processing portion is formed in at least one of side surfaces of the bar.

8. The light guide unit of claim 7,
wherein, in one surface of the light guide member opposite the optical path change processing portion, a lens for diffusing light from the optical path change processing portion is formed.

9. The light guide unit of claim 1,
wherein the light emission portion arrangement line is straight.

10. The light guide unit of claim 1,
wherein the light receiving end arrangement line intersects a direction in which the light guide members are aligned, and is perpendicular to the light emission portion arrangement line.

11. The light guide unit of claim 10 that satisfies a relational formula (1) below:
P≦(L/m)×tan(90°−2×θc) Relational formula (1)
where
P: an arrangement distance between the light guide members in the light guide member group,
L: a length from the light receiving end of the light guide member having a shortest length to a top end in an opposite side of the light receiving end of the light guide member having a longest length,
m: the number of the light guide members included in the light guide member group and
θc: a critical angle of a material of the light guide member.

12. The light guide unit of claim 9,
wherein the light guide member is bent and bar-shaped, and
in a portion extending from a bent place of the bar to a side of a top end of the bar in an opposite side to a side of the light receiving end of the light, the light emission portion is arranged, and a direction in which the light emission portion extends is perpendicular to the light receiving end arrangement line.

13. The light guide unit of claim 2,
wherein, in the light guide member group, when the light guide member is bar-shaped, as a length of the light guide member is greater, an area of the optical path change processing portion is smaller.

14. The light guide unit of claim 1,
wherein, in the light guide member group, the light guide members are connected using a coupling member.

15. The light guide unit of claim 1,
wherein the plurality of light guide member groups are symmetrically arranged about a symmetrical axis extending in the same direction as the light receiving end arrangement line.

16. The light guide unit of claim 1,
wherein the plurality of light guide member groups are symmetrically arranged about a symmetrical axis extending in a direction perpendicular to the light receiving end arrangement line.

17. An illumination device comprising:
the light guide unit of claim 1;
a diffusion member that receives light emitted from the light emission portion; and
a reflective member that sandwiches the light guide unit together with the diffusion member.

18. The illumination device of claim 17,
wherein the light emission portion includes an optical path change processing portion that is either a portion in which a fine shape for converting internal light into an optical path suitable for external emission is processed or a portion which is subjected to dot-type printing processing, and
the optical path change processing portion is planar, and a light receiving side in the surface thereof faces the diffusion member or the reflective member.

19. The illumination device of claim 18,
wherein, when the light receiving side of the optical path change processing portion faces the diffusion member, one surface of the light guide member formed in the optical path change processing portion is farthest away from the diffusion member as compared with the other surfaces.

20. The illumination device of claim 19,
wherein a distance from the diffusion member to the optical path change processing portion is longer than a distance from the reflective member to the optical path change processing portion.

21. The illumination device of claim 18,
wherein the optical path change processing portion is provided in a surface of the light guide member perpendicular to the reflective member, and is also provided in a surface of the light guide member opposite the reflective member.

22. The illumination device of claim 18,
wherein, when the light receiving side of the optical path change processing portion faces the reflective member, one surface of the light guide member formed in the optical path change processing portion is farthest away from the reflective member as compared with the other surfaces.

23. The illumination device of claim 22,
wherein a distance from the reflective member to the optical path change processing portion is longer than a distance from the diffusion member to the optical path change processing portion.

24. A display device comprising:
the illumination device of claim 17; and
a display panel that receives light from the illumination device.

25. The display device of claim 24,
wherein the light emission portion arrangement line is straight, and is along a longitudinal direction or a width direction of the display panel.
